(19) United States
(12) Patent Application Publication
(10) Pub. No.: US 2026/0318942 A1
(43) Pub. Date: Oct. 15, 2026

(54) MEASUREMENT SYSTEM, MEASUREMENT APPARATUS, AND MEASUREMENT METHOD

(71) Applicant: KOKUYO CO., LTD., Osaka (JP)

(72) Inventors: Nobuhiko NAKAI, Osaka (JP); Jun YAMAGATA, Osaka (JP)

(21) Appl. No.: 19/461,095

(22) Filed: Jan. 27, 2026

(30) Foreign Application Priority Data
Jan. 28, 2025 (JP) 2025-011950

(51) Int. Cl. G01P 15/08

(52) U.S. Cl. CPC G01P 15/08

(57) ABSTRACT

A writing apparatus 1 includes an acquisition processor 111 that acquires an acceleration of movement corresponding to a usage of a writing implement by a user, and a measurement processor 112 that counts a time during which the acceleration of the writing implement exceeds a first threshold as a first time during which the user is holding the writing implement, and counts a time during which the acceleration of the writing implement exceeds a second threshold larger than the first threshold as a second time during which the user is writing with the writing implement.

### INCORPORATION BY REFERENCE

This application is based upon and claims the benefit of priority from the corresponding Japanese Patent Application No. 2025-011950 filed on Jan. 28, 2025, the entire contents of which are incorporated herein by reference. Any and all applications for which a foreign or domestic priority claim is identified in the Application Data Sheet as filed with the present application are hereby incorporated by reference under 37 CFR 1.57.

### BACKGROUND

The present invention relates to a technology of using a measurement apparatus to acquire data corresponding to a user's act of using an object to be measured.

Conventional systems have detected the amount of movement of a writing implement, which corresponds to a user's act of writing, and have acquired and managed data (written information) such as handwriting. For example, the system has a configuration in which apparatuses such as a sensor, a control apparatus, a storage apparatus, and a communication apparatus are disposed inside a main body of a writing implement such as a mechanical pencil, and a detection value of the sensor is transmitted to an external information processing apparatus. According to the system, it is possible to acquire data (written information) corresponding to the user's act of writing.

However, in the conventional system, since the act of writing is determined on the basis of the amount of movement of the writing implement (objects to be measured), it is difficult to accurately distinguish whether the user is actually writing or merely moving the writing implement without writing. This makes it difficult to accurately grasp the usage state of the writing implement.

### SUMMARY

It is desirable to provide a measurement system, a measurement apparatus, and a measurement method that are capable of accurately grasping a user's usage state of an objects to be measured.

A measurement system according to an aspect of the present invention includes an acquisition processor and a measurement processor. The acquisition processor acquires an acceleration of movement corresponding to a usage of an object to be measured by a user. The measurement processor counts a time during which the acceleration of the object to be measured exceeds a first threshold as a first time during which the user is using the object to be measured, and counts a time during which the acceleration of the object to be measured exceeds a second threshold larger than the first threshold as a second time during which the user is using the object to be measured and performing input.

A measurement apparatus according to another aspect of the present invention is a measurement apparatus that is attachable to and detachable from an object to be measured and detects data related to a usage of the object to be measured by a user. The measurement apparatus includes: a first part including a detector that detects the data, and a controller that acquires the data detected by the detector; and a second part configured to hold the object to be measured, the second part being removably attached to the first part and replaceable depending on the object to be measured. The controller includes an acquisition processor that acquires an acceleration of movement corresponding to the usage of the object to be measured by the user, and a measurement processor that counts a time during which the acceleration of the object to be measured exceeds a first threshold as a first time during which the user is using the object to be measured, and counts a time during which the acceleration of the object to be measured exceeds a second threshold larger than the first threshold as a second time during which the user is using the object to be measured and performing input.

A measurement method according to another aspect of the present invention is a measurement method that is executed by one or more processors, the measurement method including: acquiring an acceleration of movement corresponding to a usage of an object to be measured by a user; and counting a time during which the acceleration of the object to be measured exceeds a first threshold as a first time during which the user is using the object to be measured, and counting a time during which the acceleration of the object to be measured exceeds a second threshold larger than the first threshold as a second time during which the user is using the object to be measured and performing input.

A recording medium according to another aspect of the present invention is a recording medium that records a measurement program for causing one or more processors to execute: acquiring an acceleration of movement corresponding to a usage of an object to be measured by a user; and counting a time during which the acceleration of the object to be measured exceeds a first threshold as a first time during which the user is using the object to be measured, and counting a time during which the acceleration of the object to be measured exceeds a second threshold larger than the first threshold as a second time during which the user is using the object to be measured and performing input.

According to the present invention, it is possible to provide a measurement system, a measurement apparatus, and a measurement method that are capable of accurately grasping a user's usage state of an objects to be measured.

This Summary is provided to introduce a selection of concepts in a simplified form that are further described below in the Detailed Description with reference where appropriate to the accompanying drawings. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 is a schematic view showing an overall configuration of a writing system according to an embodiment of the present invention.

FIG. 2 is a view showing an example of a method of using a writing apparatus according to the embodiment of the present invention.

FIG. 3 is an outer appearance view showing an overall configuration of the writing apparatus according to the embodiment of the present invention.

FIG. 4 is an outer appearance view showing an overall configuration of the writing apparatus according to the embodiment of the present invention.

FIG. 5 is a side view showing an overall configuration of the writing apparatus according to the embodiment of the present invention.

FIG. 6 is a front view showing an overall configuration of the writing apparatus according to the embodiment of the present invention.

FIG. 7 is an exploded perspective view of the writing apparatus according to the embodiment of the present invention.

FIG. 8 is an exploded perspective view of the writing apparatus according to the embodiment of the present invention.

FIG. 9 is a perspective view showing a configuration of a main body lower part of the writing apparatus according to the embodiment of the present invention.

FIG. 10 is a bottom view showing an overall configuration of the writing apparatus according to the embodiment of the present invention.

FIG. 11 is a cross-sectional view of the writing apparatus according to the embodiment of the present invention.

FIG. 12 is an outer appearance view showing an overall configuration of a housing case according to the embodiment of the present invention.

FIG. 13 is an outer appearance view showing an overall configuration of the housing case according to the embodiment of the present invention.

FIG. 14 is a perspective view showing a state in which the writing apparatus is housed in the housing case according to the embodiment of the present invention.

FIG. 15 is a perspective view showing a state in which the writing apparatus is taken from the housing case according to the embodiment of the present invention.

FIG. 16 is a block diagram showing an overall configuration of the writing system according to the embodiment of the present invention.

FIG. 17 is a flowchart showing an example of data acquisition processing executed in the writing system according to the embodiment of the present invention.

FIG. 18A is a flowchart showing an example of written information display processing executed in the writing apparatus according to the embodiment of the present invention.

FIG. 18B is a flowchart showing an example of the written information display processing executed in an operation terminal according to the embodiment of the present invention.

FIG. 19 is an example of an operation screen of the operation terminal according to the embodiment of the present invention.

FIG. 20 is an example of the operation screen of the operation terminal according to the embodiment of the present invention.

FIG. 21 is an example of the operation screen of the operation terminal according to the embodiment of the present invention.

FIG. 22 is an example of the operation screen of the operation terminal according to the embodiment of the present invention.

FIG. 23 is an example of the operation screen of the operation terminal according to the embodiment of the present invention.

FIG. 24 is a conceptual diagram showing a usage state of the writing apparatus according to the embodiment of the present invention.

FIG. 25 is a graph showing a relationship between an angle and acceleration and a usage state of the writing apparatus according to the embodiment of the present invention.

FIG. 26 is a graph showing a relationship between the angle and acceleration and the usage state of the writing apparatus according to the embodiment of the present invention.

### DETAILED DESCRIPTION

Hereinafter, an embodiment of the present disclosure will be described with reference to the accompanying drawings for the purpose of understanding the present invention. Note that the following embodiment is an example embodying the present invention and is not intended to limit the technical scope of the present invention.

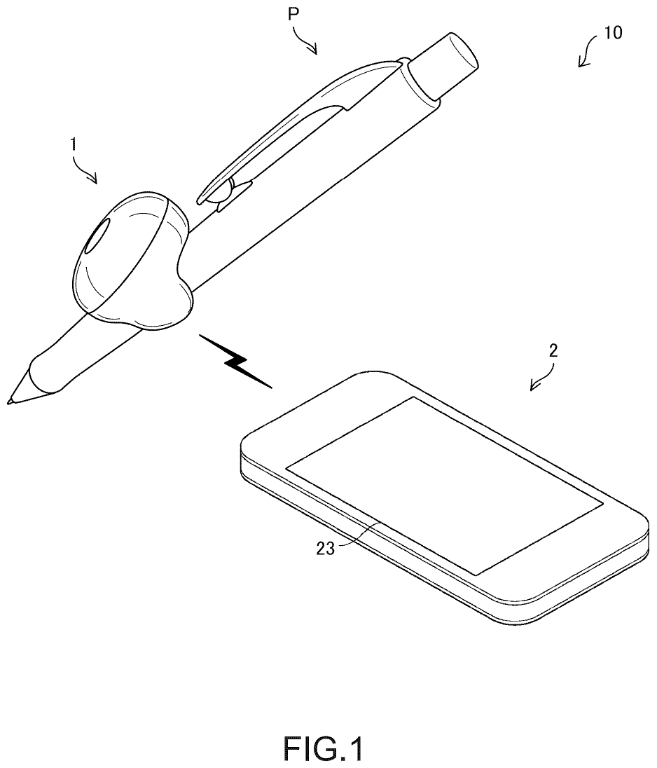

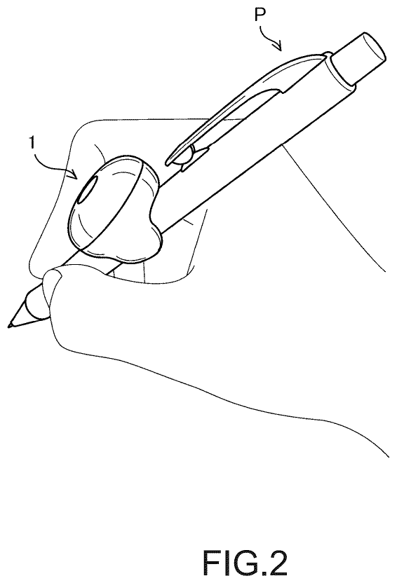

The present invention is a system that acquires data (act information) corresponding to a user's act of using an object to be measured and presents information corresponding to the data to the user. For example, the present invention is applicable to a learning system that acquires data (learning information) corresponding to a user's learning act of learning with a learning tool and presents information corresponding to the data to the user. A writing system 10 (learning system) according to this embodiment is an example of a measurement system of the present invention, and includes, as shown in FIG. 1, a writing apparatus 1 attachable to an detachable from a writing implement P, and an operation terminal 2 capable of data communication with the writing apparatus 1. The writing apparatus 1 is an example of a measurement apparatus of the present invention. As shown in FIG. 2, the user attaches the writing apparatus 1 to any position of the writing implement P and performs an act of writing. The writing implement P is an example of an object to be measured of the present invention, and is, for example, a ready-made (general-purpose) writing implement such as a mechanical pencil, a ballpoint pen, a pencil, or an electronic pen (touch pen, stylus pen, etc.). The object to be measured of the present invention is not limited to the writing implement P, and may be, for example, a user's finger. For example, the user may attach the writing apparatus 1 to his/her finger and perform an act of writing on a touch panel or the like.

When the user performs an act of writing using a writing implement P with the writing apparatus 1 attached thereto, the writing apparatus 1 detects data (written information) such as the amount of movement and the speed of movement of the writing implement P and transmits the detected data to the operation terminal 2 of the user. When receiving the data from the writing apparatus 1, the operation terminal 2 displays various types information corresponding to the act of writing. The operation terminal 2 is, for example, a smartphone (see FIG. 1) of the user or a personal computer and can check the information related to his/her act of writing. For example, the user sets his/her own learning goal (e.g., acquisition of a qualification) and learns toward the goal using the writing apparatus 1. In addition, the user continues learning toward the goal while checking the information acquired by the writing apparatus 1.

By the way, the technologies capable of acquiring the information related to the user's act of writing have been proposed conventionally, but there is a problem in that writing implements that can be used by the user are limited. On the other hand, the writing apparatus according to the present invention is applicable to various writing implements (writing objects) and can improve the user's convenience. In addition, the writing system according to the present invention can maintain and improve the user's motivation for learning by presenting various types of information related to the user's act of writing to the user. The specific configuration of the writing system 10 according to this embodiment to achieve the above effects will be described below.

### Writing Apparatus 1

### Structure of Writing Apparatus 1

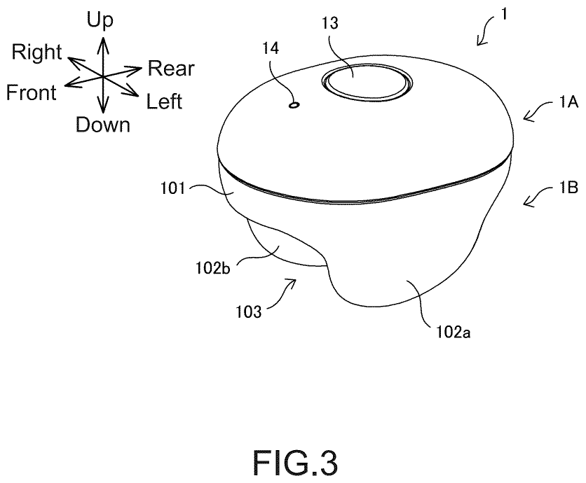

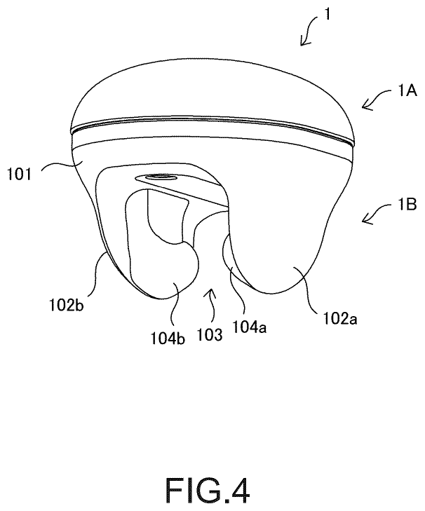

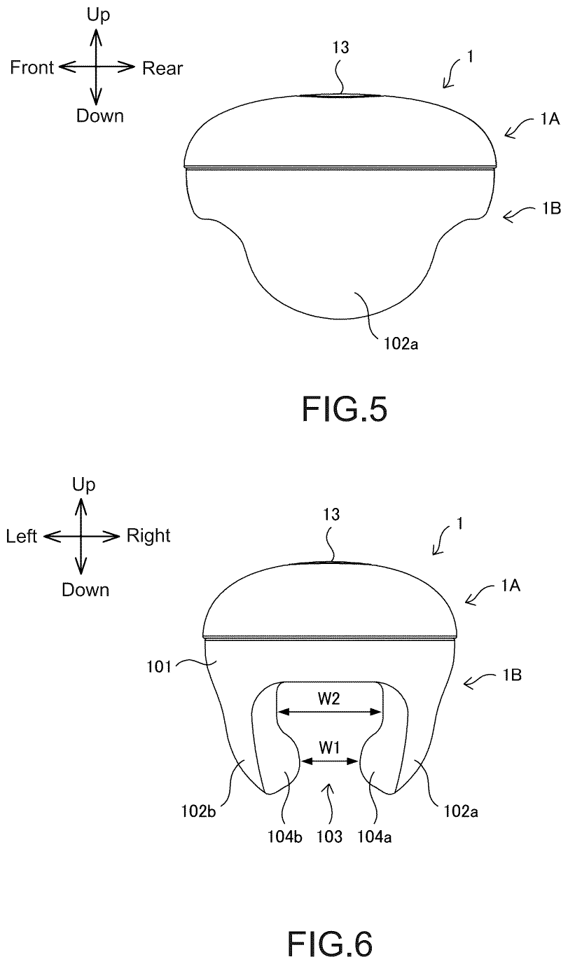

FIG. 3 is an outer appearance view of the writing apparatus 1 viewed from obliquely above. FIG. 4 is an outer appearance perspective view of the writing apparatus 1 viewed from obliquely below. FIG. 5 is a side view of the writing apparatus 1, and FIG. 6 is a front view of the writing apparatus 1. Note that in FIG. 3 etc. the upper direction, the lower direction, the left direction, the right direction, the front direction, and the rear direction are defined for convenience of description and do not limit the present invention.

The writing apparatus 1 includes a main body upper part 1A (an example of a first part of the present invention) and a main body lower part 1B (an example of a second part of the present invention), and the main body upper part 1A and the main body lower part 1B can be separated from each other. FIGS. 3 to 6 show the main body upper part 1A and the main body lower part 1B connected to each other. The user can detach the main body lower part 1B from the main body upper part 1A. In addition, if several types of main body lower part 1B are prepared in accordance with the size (thickness) of the writing object, the user can replace the main body lower part 1B depending on the writing implement P to be used. In other words, the main body lower part 1B is configured to be removably attached to the main body upper part 1A and replaceable depending on the writing object.

The writing apparatus 1 is formed in an oval shape as a whole in top view, and its upper part (main body upper part 1A) is formed in a bowl shape in side view. The lower part of the writing apparatus 1 (main body lower part 1B) has a structure capable of holding the writing implement P. The writing apparatus 1 has a length of approximately 30 mm in the front-rear direction, a length of approximately 25 mm in the right-left direction, and a length of approximately 22 mm in the upper-lower direction (the height from the lower end of the main body lower part 1B to the upper end of the main body upper part 1A). In addition, the main body upper part 1A has a length of approximately 8 mm in the upper-lower direction (the height from the boundary with the main body lower part 1B). The external dimensions of the writing apparatus 1 are not limited to those dimensions.

In the main body upper part 1A, functional units (details thereof will be described later) for detecting the data corresponding to an act of writing are disposed. In addition, in the main body upper part 1A, an operation button 13 and an LED 14 are disposed. The operation button 13 is a power supply button for turning on/off the power supply of the writing apparatus 1. The LED 14 is a display that displays a power supply state (e.g., charging state), an operating status (e.g., status of accumulated time of the act of writing), and the like of the writing apparatus 1. In top view, the operation button 13 is disposed at the center position of the main body upper part 1A (the center position in the front-rear and right-left directions), and the LED 14 is disposed at a position shifted from the center position of the main body upper part 1A in the longitudinal direction. Note that the LED 14 may be disposed at the center position of the main body upper part 1A and the operation button 13 may be disposed at a position shifted from the center position of the main body upper part 1A in the longitudinal direction. The main body upper part 1A is formed of a resin material and includes the functional units inside.

The main body lower part 1B includes a base 101, right and left holding portions 102a and 102b that respectively extend downward from right and left side ends of the base 101, a protrusion 104a that protrudes to the inside of the main body lower part 1B from the holding portion 102a, and a protrusion 104b that protrudes to the inside of the main body lower part 1B from the holding portion 102b. The base 101 is formed in an oval shape in top view and is connected to the main body upper part 1A. A space 103 (see FIG. 6) capable of accommodating the writing implement P is formed between the holding portions 102a and 102b. The holding portions 102a and 102b are examples of a first holding portion and a second holding portion of the present invention.

As shown in FIG. 6, the holding portion 102a is provided at the right side end of the base 101 and provided to extend downward from the right side end. The protrusion 104a that protrudes in the left direction (toward the space 103) is provided at the lower end of the holding portion 102a. The holding portion 102b is provided at the left side end of the base 101 and provided to extend downward from the left side end. The protrusion 104b that protrudes in the right direction (toward the space 103) is provided at the lower end of the holding portion 102b.

In other words, the protrusion 104a and the protrusion 104b are disposed to face each other with a predetermined interval (width W1) therebetween on the lower side (at the lower end) of the main body lower part 1B. The space 103 having a width W2 larger than the width W1 is formed above the protrusion 104a and the protrusion 104b. The length of the holding portions 102a and 102b in the upper-lower direction is set to a length capable of securing the space 103 for accommodating the writing implement P.

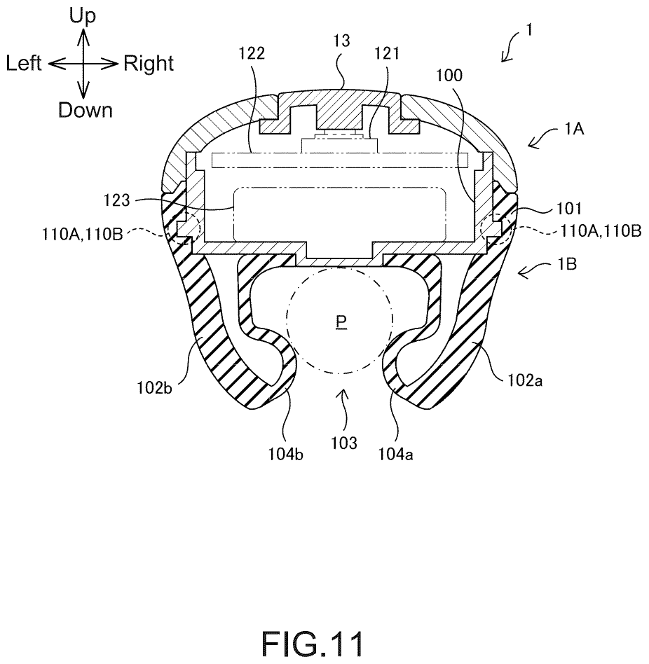

The main body lower part 1B is formed of an elastic material such as silicone or rubber, and the base 101, the holding portions 102a and 102b, and the protrusions 104a and 104b are integrally formed. In addition, in the holding portion 102a, a width in the right-left direction at the center (close to the space 103) is thinner than a width in the right-left direction at a lower tip (close to the protrusion 104a). In the holding portion 102b, a width in the right-left direction at the center (close to the space 103) is thinner than a width in the right-left direction at a lower tip (close to the protrusion 104b). Accordingly, the lower tip (close to the protrusion 104a) of the holding portion 102a and the lower tip (close to the protrusion 104b) of the holding portion 102b are elastically deformable in the right-left direction. Thus, for example, when the writing apparatus 1 is attached to the writing implement P, the writing implement P is accommodated in the space 103 having the width W2, while the holding portions 102a and 102b of the main body lower part 1B are deformed to expand outward. In addition, the protrusions 104a and 104b each have a space inside (see FIG. 11), and the space has a cushioning function of absorbing the deformed site when the lower tip of each of the holding portions 102a and 102b is deformed. This can prevent the holding portions 102a and 102b from expanding outward too much when the writing apparatus 1 is attached to the writing implement P, thus preventing the holding portions 102a and 102b from coming into contact with and being in the way of the user's fingers when the user holds the writing implement P. When the writing implement P is accommodated in the space 103, the protrusions 104a and 104b clamp (hold) the writing implement P by elastic force (restoring force) in the direction in which the protrusions 104a and 104b face each other (inward). When the writing implement P is accommodated in the space 103, the protrusions 104a and 104b function as stoppers to prevent the writing implement P from falling from the writing apparatus 1. In such a manner, since the main body lower part 1B has an elastically deformable configuration, the writing apparatus 1 can be attached to writing implements P with various thicknesses. In addition, the user can easily attach and detach the writing apparatus 1 to and from the writing implement P.

Further, since the main body lower part 1B is configured to be detachable from the main body upper part 1A, for example, several types of main body lower part 1B with different intervals (widths W1) between the protrusions 104a and 104b may be prepared. For example, reducing the width (thickness) in the right-left direction of each of the protrusions 104a and 104b makes it possible to form a main body lower part 1B with a large width W1, and increasing the width (thickness) in the right-left direction of each of the protrusions 104a and 104b makes it possible to form a main body lower part 1B with a narrow width W1. Preparing several types of main body lower part 1B further makes it possible to attach the writing apparatus 1 to writing implements P with various thicknesses. In addition, the writing apparatus 1 can also be attached to a writing object (user's finger, information processing apparatus such as the operation terminal 2, and the like) other than the writing implement P. In such a manner, the writing apparatus 1 has a configuration in which the main body lower part 1B can be separated from the main body upper part 1A and the main body lower part 1B can be replaced depending on a writing object.

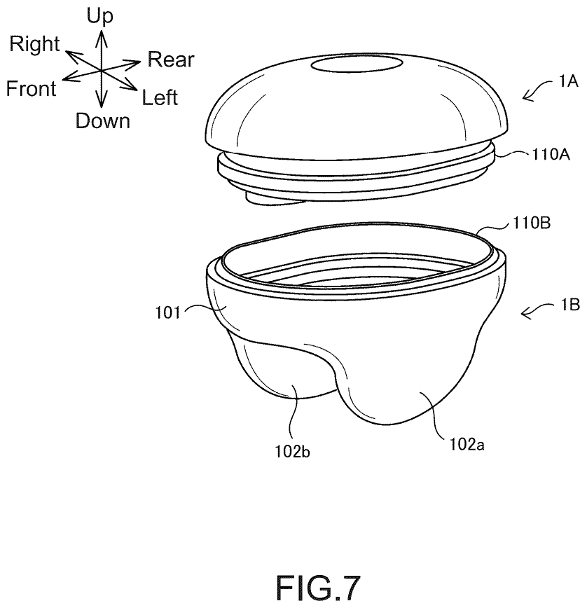

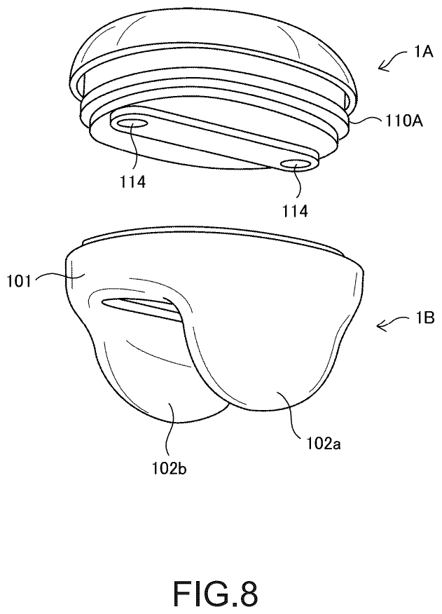

Note that FIGS. 7 and 8 show a state in which the main body upper part 1A and the main body lower part 1B are separated from each other. A fitting portion 110A (protrusion) is formed at a lower end of the main body upper part 1A, and a fitted portion 110B into which the fitting portion 110A is inserted is formed at an upper end of the main body lower part 1B. The main body upper part 1A and the main body lower part 1B are put to face each other and pushed into each other in the upper-lower direction, and thus the fitting portion 110A is inserted into the fitted portion 110B to be fitted (connected). In addition, with the main body upper part 1A and the main body lower part 1B being fitted, when the user pulls a fitted portion (boundary portion) of the main body upper part 1A and the main body lower part 1B in the opposite up-down directions, the fitting portion 110A and the fitted portion 110B are detached from each other, so that the main body upper part 1A and the main body lower part 1B can be separated from each other. Note that the main body upper part 1A and the main body lower part 1B can be connected to each other irrespective of the orientations in the front-rear direction (longitudinal direction). In other words, the main body upper part 1A and the main body lower part 1B have the symmetric forms in the front-rear direction (longitudinal direction), and the user can connect and separate them without worrying about the front-rear direction of each part.

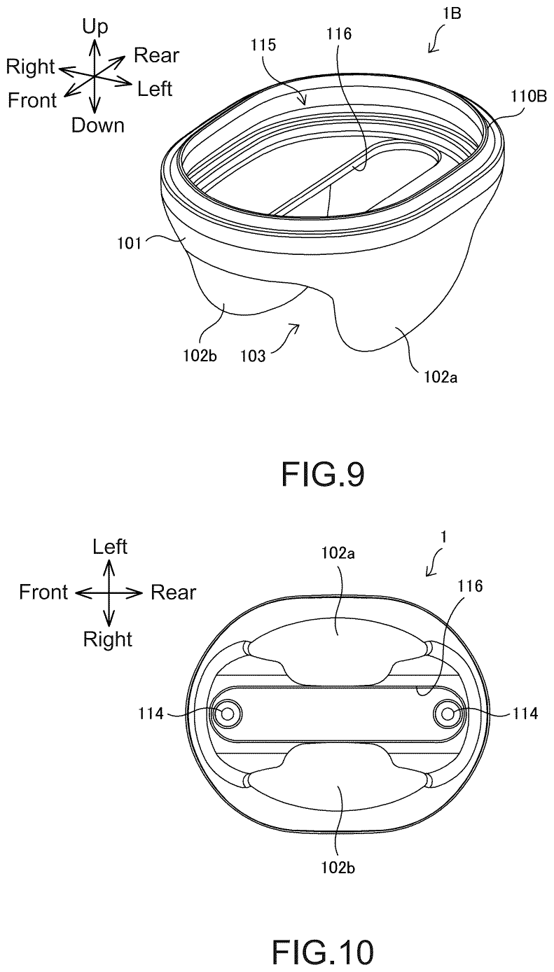

FIG. 9 shows an outer appearance perspective view of the main body lower part 1B. An inner space 115 for accommodating the functional units disposed in the main body upper part 1A is formed in the base 101 of the main body lower part 1B. In addition, an opening 116 is formed in the bottom surface of the base 101, and a charging terminal 114 included in the functional units is inserted into the opening 116. FIG. 10 shows a bottom view of the writing apparatus 1. As shown in FIG. 10, when the main body upper part 1A and the main body lower part 1B are fitted into each other, the charging terminal 114 is exposed to the outside from the opening 116.

FIG. 11 is a cross-sectional view of the writing apparatus 1. A battery 123 (lithium-ion battery) that supplies power to the writing apparatus 1, a control board 122 on which a sensor, an IC, and the like are mounted, and a switch 121 (tact switch) mounted on the control board 122 and connected to the operation button 13 are disposed inside the main body upper part 1A. Note that the battery 123 is connected to the charging terminal 114 (see FIGS. 8 and 10). The functional units are mounted on the bottom portion 100 of the main body upper part 1A, and the bottom portion 100 is connected to the main body lower part 1B.

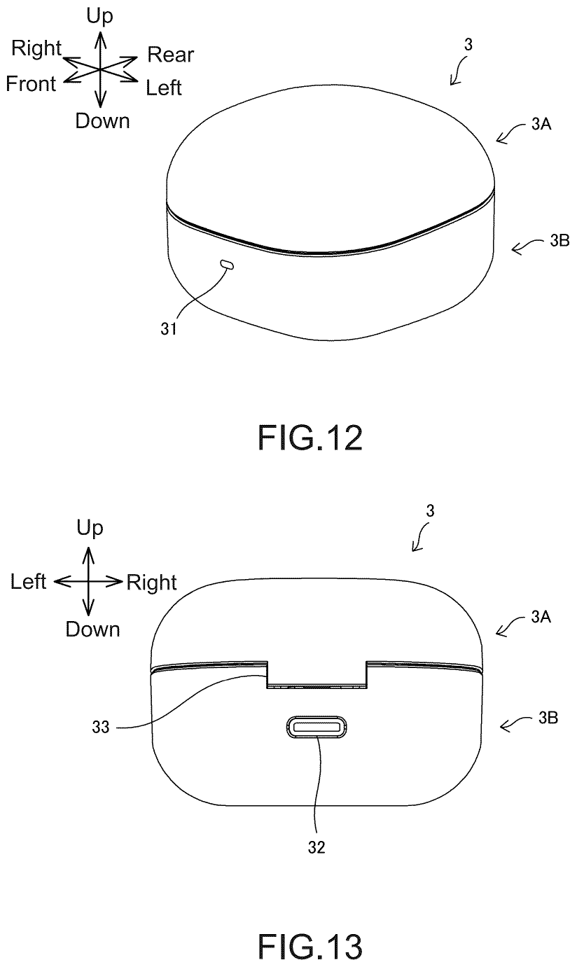

The writing apparatus 1 can be housed in a housing case 3 shown in FIG. 12. When the writing apparatus 1 is housed in the housing case 3, the battery 123 can be charged. The housing case 3 includes a housing portion 3B and a lid portion 3A. The lid portion 3A is connected to the housing portion 3B in a openable and closable manner via a connection portion 33 (hinge). As shown in FIG. 13, a power supply connection portion 32 into and from which a power cable (not shown) is inserted and disconnected is disposed on the back surface of the housing portion 3B. When the power cable is inserted into the power supply connection portion 32, power is supplied to a battery (not shown) in the housing case 3, the battery of the housing case 3 is charged, and power is supplied from that battery to the battery 123 of the writing apparatus 1 housed in the housing case 3 to change the battery 123. Note that if the battery of the housing case 3 is charged in advance, the user can charge the writing apparatus 1 without using the power cable. An LED 31 is disposed on the front surface of the lid portion 3A. The LED 31 lights up, blinks, or turns off, for example, in a manner that the charged state of the battery 123 is distinguishable.

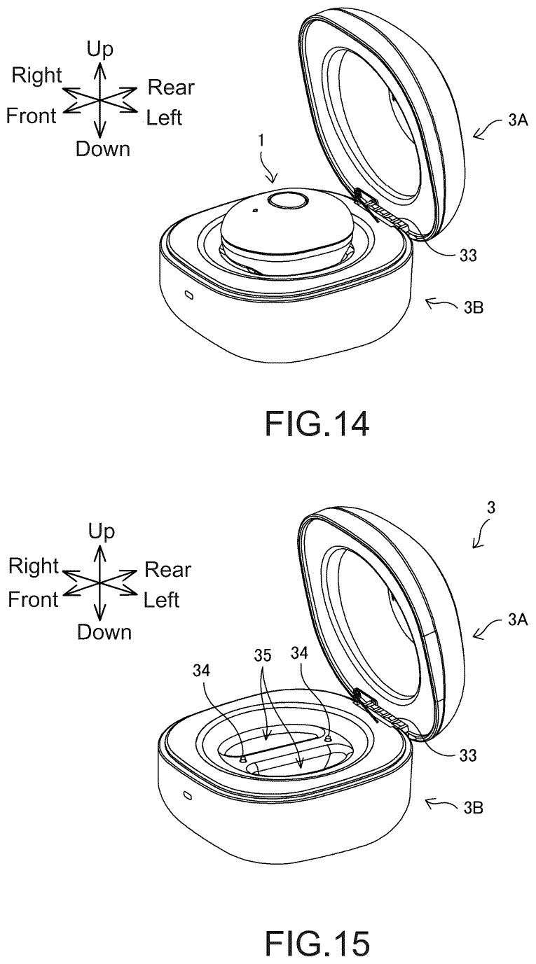

FIG. 14 shows a state in which the writing apparatus 1 is housed in the housing case 3. FIG. 15 shows a state in which the writing apparatus 1 is removed from the housing case 3. The user can open or close the lid portion 3A to hose the writing apparatus 1 int the housing case 3 or take it out from the housing case 3. An insertion portion 35 (recess) into which the holding portions 102a and 102b of the writing apparatus 1 are inserted is provided to the housing portion 3B. The insertion portion 35 has a shape corresponding to the size and shape of the holding portions 102a and 102b, and serves to protect the holding portions 102a and 102b when the writing apparatus 1 is housed in the housing case 3.

In addition, a charging terminal 34 is disposed in the housing portion 3B, and power is supplied to the charging terminal 34 from the power cable or the battery of the housing case 3. When the writing apparatus 1 is housed in the housing portion 3B, the charging terminal 114 of the writing apparatus 1 (see FIGS. 8 and 10) is connected to the charging terminal 34 of the housing portion 3B. This makes it possible to charge the battery 123 when the writing apparatus 1 is housed in the housing case 3.

In such a manner, when the user does not use the writing apparatus 1, the user can charge the writing apparatus 1 by housing the writing apparatus 1 in the housing case 3. In addition, with the writing apparatus 1 being housed in the housing case 3, the user can carry the writing apparatus 1 while protecting it without being conscious of charging.

### Function of Writing Apparatus 1

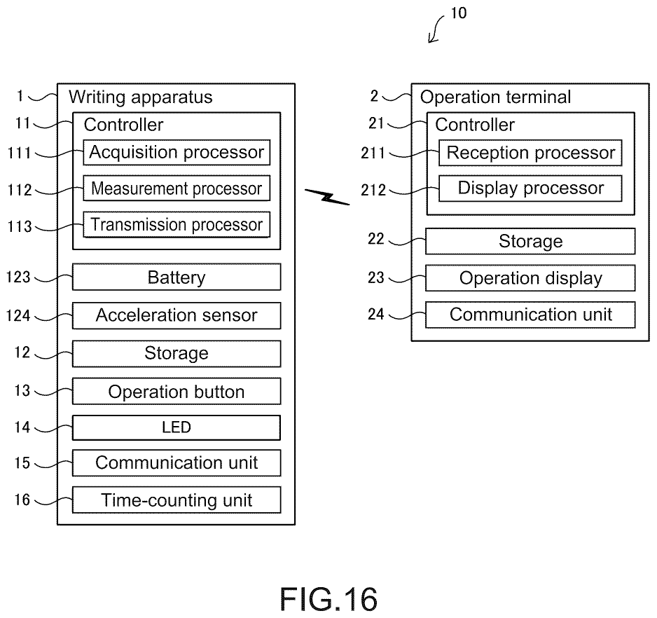

When the user performs an act of writing by using the writing implement P to which the writing apparatus 1 is attached, the writing apparatus 1 acquires data (written information) corresponding to the act of writing and transmits the data to the operation terminal 2. FIG. 16 is a functional block diagram showing a configuration of the writing apparatus 1.

The writing apparatus 1 includes a controller 11, the battery 123, an acceleration sensor 124, a storage 12, the operation button 13, the LED 14, a communication unit 15, a time-counting unit 16, and the like.

The communication unit 15 is a communication interface for connecting the writing apparatus 1 to a communication network wirelessly and executing data communication, according to a predetermined communication protocol, with an external apparatus such as the operation terminal 2 via the communication network. For example, the communication unit 15 includes a wireless transceiver for wireless communication via Bluetooth (registered trademark), a wireless LAN, a cellular phone network, a WiMAX network, etc., or an RFID card or a chip.

The time-counting unit 16 is an internal clock that measures (counts) time inside the writing apparatus 1. The time-counting unit 16 starts and ends the counting of time according to an instruction of the controller 11. The controller 11 acquires the counted time of the time-counting unit 16, for example, the start time and end time of the act of writing, and stores them in the storage 12.

The acceleration sensor 124 is a so-called six-axis acceleration sensor or nine-axis acceleration sensor, for example, having a function of a three-axis acceleration sensor that measures accelerations along the three-axis directions of the X-axis, the Y-axis, and the Z-axis orthogonal to each other, and a function of a three-axis rotation angular velocity sensor (gyro sensor) that measures angular velocities along rotation directions of a θ direction around the X-axis, a φ direction around the Y-axis, and a Ψ direction around the Z-axis. Note that the acceleration sensor 124 is not limited to the six-axis acceleration sensor or the nine-axis acceleration sensor, but may also be a three-axis acceleration sensor. For example, the acceleration sensor 124 may be a three-axis acceleration sensor that measures an acceleration without measuring an angular velocity. Use of the acceleration sensor 124 makes it possible to detect the acceleration of the motion of (the tip of) the writing implement P, calculate the speed of the motion of the writing implement P through the time integration of acceleration or the integration of a time series of repetitively measured acceleration, and calculate the displacement of the motion of the writing implement P through the time integration of speed or the integration of a time series of repetitively calculated speed. Incidentally, the nine-axis acceleration sensor also has a function of a three-axis geomagnetic sensor (electronic compass) to determine the directions of north, south, east and west, but this function of a geomagnetic sensor is not necessarily required. The acceleration sensor 124 is an example of a detector of the present invention.

The battery 123 supplies the power necessary for each unit (hardware resources) of the writing apparatus 1. Note that instead of the battery 123 or together with the battery 123, a power generation apparatus that generates power by utilizing the motion (vibration) applied to the writing apparatus 1 and supplies power or performs charging may be mounted on the writing apparatus 1.

The operation button 13 is a power supply button to turn on/off the power supply of the writing apparatus 1. The user presses the operation button 13 to turn on the power supply of the writing apparatus 1, and then starts writing.

The LED 14 indicates (lights up, blinks, or turns off) the power supply state (on/off state, charging state) and an operating status (moving state of the writing implement P) of the of the writing apparatus 1 and the like in a distinguishable manner. In addition, the LED 14 displays different colors in accordance with the accumulated time of the act of writing. For example, the LED 14 changes its lighting color as the “time of writing” during which the user is performing the act of writing increases. Note that the LED 14 changes its lighting color only on the basis of the “time of writing”, without counting “time of not writing” during which the user is not performing the act of writing. This motivates the user to learn because the color of the LED 14 changes in accordance with the user's original learning time. Note that the LED 14 may change its color in accordance with an elapsed time since the power supply has been turned on.

Note that the user may be allowed to set the LED 14 to be turned on/off. For example, if the user feels that the LED 14 is too bright during the act of writing, the user may set the LED 14 to be turned off in the operation terminal 2. In addition, it may also be possible to set the LED 14 to be turned on only when the accumulated time of the act of writing reaches a predetermined time, while the LED 14 is turned off during the act of writing.

As another embodiment, the writing apparatus 1 may include a vibration element and cause the vibration element to vibrate in accordance with the accumulated time of the act of writing. The writing apparatus 1 may also change a vibration pattern in accordance with the accumulated time of the act of writing. In addition, the writing apparatus 1 may cause the vibration element to vibrate in accordance with an elapsed time since the power supply has been turned on.

The storage 12 is a nonvolatile storage such as a hard disk drive (HDD), a solid state drive (SSD), or a flash memory that stores various types of information. The storage 12 stores detection data of the acceleration sensor 124 and other information. When the controller 11 acquires detection data from the acceleration sensor 124, the controller 11 stores data related to the act of writing in a predetermined storage area of the storage 12.

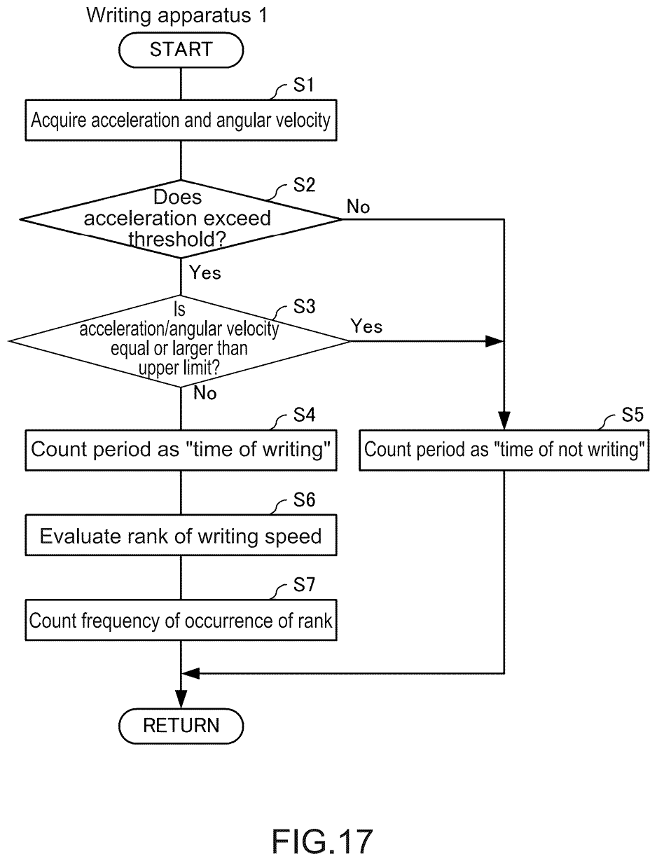

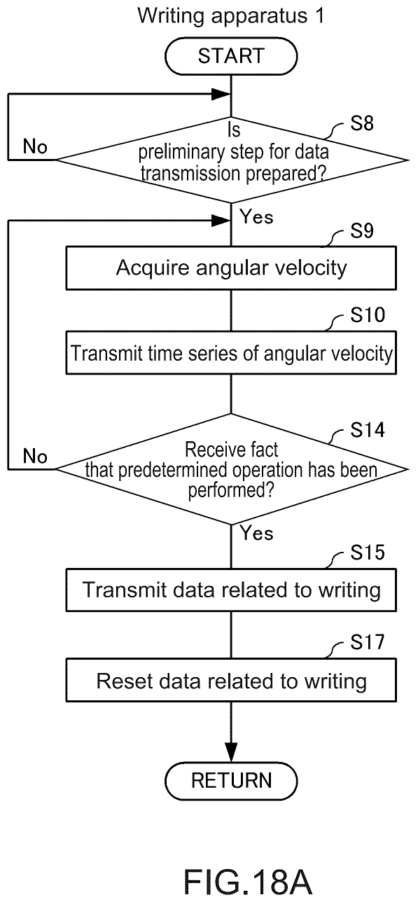

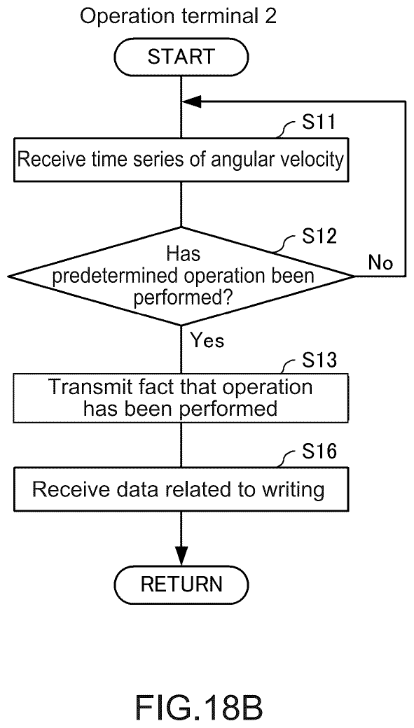

In addition, the storage 12 stores control programs such as a data acquisition program for causing the controller 11 to execute data acquisition processing (see FIG. 17) to be described later and a written information display program for causing the controller 11 to execute written information display processing (see FIGS. 18A and 18B) to be described later. For example, the data acquisition program and the written information display program are non-transiently recorded on a computer-readable recording medium such as a CD or a DVD, read by a reader (not shown) of the writing apparatus 1, and stored in the storage 12.

The controller 11 includes control devices such as a CPU, a ROM, or a RAM. The CPU is a processor that executes various types of arithmetic processing. The ROM is a nonvolatile storage in which control programs such as the BIOS and the OS for causing the CPU to execute various types of arithmetic processing are stored in advance. The RAM is a volatile or nonvolatile storage that stores various types of information, and is used as a temporary storage memory (work area) for the CPU to execute various types of processing. The controller 11 then executes various control programs stored in advance in the ROM or the storage 12 by the CPU, thus controlling the writing apparatus 1.

Specifically, as shown in FIG. 16, the controller 11 includes various processors such as an acquisition processor 111, a measurement processor 112, and a transmission processor 113. Note that the controller 11 functions as the various processors by the CPU executing various types of processing according to the data acquisition program and the written information display program. In addition, some or all of the processors may be configured by electronic circuits. Note that the data acquisition program and the written information display program may be programs for causing one or more processors to function as the processors described above.

The acquisition processor 111 acquires, by using the acceleration sensor 124, quantified data related to the act of writing by the user using the writing implement P. The acquisition processor 111 also stores and retains the acquired data in a predetermined storage area of the storage 12.

In this embodiment, the data related to the act of writing includes the amount of writing in the user's act of writing and a writing speed in the act of writing. The amount of writing indicates the amount of the act of writing performed by the user. More specifically, the amount of writing is an integrated value of the time spent in the act of writing, an integrated value of the displacement, which is the distance in which the tip of the writing implement P is moved in the act of writing, and the number of strokes written or the number of letters written. It can be said that as the amount of writing increases, the user becomes more accustomed to write or the degree of attainment in learning or training increases. The writing speed indicates the speed of writing in the act of writing and the number of strokes written or letters written by the user in a given time. More specifically, the writing speed is an angular velocity or speed of the movement of the tip of the writing implement P during the act of writing. It can be said that as the speed of writing is faster, i.e., as the user writes faster, the user's ability to write becomes higher and the user can concentrate more on learning and other tasks that involve writing.

The collection itself of the data related to the act of writing by the writing apparatus 1 does not involve the operation terminal 2, and the existence of the operation terminal 2 and the communication between the writing apparatus 1 and the operation terminal 2 are not necessary.

### Data Acquisition Processing

FIG. 17 shows a procedure of the processing for acquiring the data related to the act of writing (data acquisition processing) in the controller 11 of the writing apparatus 1. The acquisition processor 111 obtains the accelerations [X, Y, Z] of the three axes and the angular velocities [θ, φ, Ψ] of rotation around the three axes via the acceleration sensor 124 at every predetermined time, for example, every frame (one frame is 1/30 second or 1/60 second) (Step S1). The writing apparatus 1 is attached to the writing implement P used by the user, and the accelerations and the angular velocities measured by the acceleration sensor 124 suggest the accelerations and the angular velocities of the motion of (the tip of) the writing implement P. At that time, a predetermined axis, for example, the Z-axis, of the acceleration sensor 124 is set in advance to be parallel or substantially parallel to the axial direction of the writing implement P, that is, the direction in which the writing implement P extends. Note that the writing apparatus 1 is configured to be capable of detecting the user's act of writing even when the orientations of the front-rear direction are reversed. In other words, the controller 11 can detect the act of writing in a similar manner even if the front and the rear of the writing apparatus 1 with respect to the writing implement P 1 is in any direction.

The accelerations and angular velocities acquired in Step S1 may be raw values output by the acceleration sensor 124 or may be calculated values obtained by computing based on the output value of the acceleration sensor 124, that is, calculated values obtained by, for example, substituting the raw values output by the acceleration sensor 124 into a predetermined function expression. For example, when the Z-axis of the acceleration sensor 124 is aligned with the extending direction of the axis of the writing implement P, it is assumed that, in the act of writing using the writing implement P, the Z-axis is substantially orthogonal to a writing surface on which writing is performed (surface of paper etc. on which writing is performed), and the tip of the writing implement P is displaced in the X-axis direction and the Y-axis direction during writing. However, it is not guaranteed that the Z-axis and the writing surface are constantly orthogonal to each other, and it is natural that the Z-axis may be tilted with respect to the writing surface. Therefore, in order to accurately obtain the acceleration, speed, or displacement of the movement of the tip of the writing implement P on the writing surface, it is necessary to detect the tilt of the Z-axis with respect to the writing surface, that is, the horizontal surface, on the basis of the gravity acting on the acceleration sensor 124, and then convert the raw output values [X, Y, Z] of the acceleration sensor 124 into acceleration values [X′, Y′, Z′] in which the tilt has been corrected. If the angle of the Z-axis, which is the axis of the writing implement P, with respect to the writing surface is constant during writing, the acceleration values [X′, Y′] in which the tilt has been corrected are the accelerations of the movement of the tip of the writing implement P on the writing surface, that is, the accelerations along the two-axis directions parallel to the writing surface and orthogonal to each other. The acceleration value along the Z′-axis direction is zero unless the tip of the writing implement P approaches or moves away from the writing surface (the Z′-axis direction is a direction orthogonal to the writing surface. Of course, it is natural that the tip of the writing implement P is displaced in the Z′-axis direction unless the wiring is performed by a single stroke.)

However, since the angle of the axis of the writing implement P can change during the act of writing, the function of the acceleration sensor 124 as an angular velocity sensor is used to detect its angular change or rotation, and a rotation matrix that cancels out the rotation of the writing implement P is further applied to the acceleration values [X′, Y′, Z′] in which the tilt has been corrected, which makes it possible to calculate the accelerations of the movement of the tip of the writing implement P on the writing surface with even higher accuracy.

Nevertheless, the requirement for accuracy of the data related to the act of writing is not always remarkably high. Moreover, the writing surface in reality is not always horizontal, and there is a possibility that the top of a desk is slightly tilted as in the case of a desk in a university lecture room or that the writing surface is a vertical surface as in the case of writing on a whiteboard. Therefore, it is not essential to apply the above-mentioned correction to the output values of the acceleration sensor 124.

The accelerations and angular velocities acquired in Step S1 may be obtained by performing some filter processing on the raw values output by the acceleration sensor 124. If the output value of the acceleration sensor 124 frequently fluctuates or pulsates, a moving average of the output value of the acceleration sensor 124 can be calculated, or the output value of the acceleration sensor 124 can be low-pass filtered to obtain appropriate acceleration and angular velocity with the fluctuation or pulsation suppressed.

Next, the measurement processor 112 takes a predetermined number of consecutive frames, for example, ten frames, as one period, and calculates, for each period, a total of absolute values (e.g., √(X2+Y2) or √(X′2+Y′2)) of accelerations of respective frames included in the period, that is, the sum of the absolute values of the ten accelerations. Under the condition that the total value exceeds a determination threshold (Step S2: Yes), the measurement processor 112 then counts the period as a “time of writing” during which the user is performing the act of writing (Step S4). If the total value does not exceed a determination threshold (Step S2: No), the measurement processor 112 counts the period as a “time of not writing” during which the user is not performing the act of writing (Step S5).

It should be noted that even if the total of the absolute values of the accelerations of the respective frames in a certain period exceeds the determination threshold, such a period cannot be immediately determined to be a “time of writing”. This is because the acceleration of the motion of the writing implement P, which is detected by the acceleration sensor 124, may be increased due to a cause other than the act of writing. If the user is a child or the like, it is not difficult to imagine that the user plays by shaking, turning, or rolling the writing implement P. Therefore, even if the determination result in Step S2 is true, when the absolute value of the acceleration or angular velocity of the motion of the writing implement P, which is detected via the acceleration sensor 124, is equal to or larger than a predetermined upper limit or exceeds it in the period or in the frame included in the period (Step S3: Yes), the measurement processor 112 determines that such large motion is not due to the act of writing and counts that period as a “time of not writing” during which the user is not performing the act of writing (Step S5).

The value of the acceleration or angular velocity referenced in Step S3 (compared with the upper limit) may be a raw output value of the acceleration sensor 124 or may be a calculated value obtained by computing based on the output value of the acceleration sensor 124, particularly, a value subjected to the correction described above, filter processing, or the like. In addition, it is discretionally determined in which direction of the X-axis, the Y-axis, and the Z-axis the acceleration is referred to, and in which rotation direction of the θ direction, the φ direction, and the Ψ direction the angular velocity is referred to.

When the Z-axis of the acceleration sensor 124 is aligned with the extending direction of the axis of the writing implement P, the absolute value of the acceleration in the Z-axis direction is expected to become excessive when the user shakes the writing implement P up and down, and the absolute value of the acceleration in the X-axis or Y-axis direction is expected to become excessive when the user shakes the writing implement P to the right and left. In addition, the absolute value of the angular velocity in the θ direction or φ direction is expected to become excessive when the user turns the writing implement P, and the absolute value of the angular velocity in the Ψ direction is expected to become excessive when the user rolls the writing implement P around its axis. The measurement processor 112 compares the absolute values of the acceleration in the X-axis direction, the acceleration in the Y-axis direction, the acceleration in the Z-axis direction, the angular velocity in the θ direction, the angular velocity in the φ direction, and the angular velocity in the Ψ direction, measured for each frame in the target period, with the upper limits respectively corresponding thereto, and if any of them is equal to or larger than the upper limit or exceeds the upper limit, the measurement processor 112 counts that period as “time of not writing”. Alternatively, the measurement processor 112 may compare a total value of the absolute values of the accelerations in the X-axis direction (the sum of the ten absolute values), a total value of the absolute values of the accelerations in the Y-axis direction, a total value of the absolute values of the accelerations in the Z-axis direction, a total value of the absolute values of the angular velocities in the θ direction, a total value of the absolute values of the angular velocities in the φ direction, and a total value of the absolute values of the angular velocities in the Ψ direction, measured for each frame in the period, with the upper limits respectively corresponding thereto, and if any of them is equal to or larger than the upper limit or exceeds the upper limit, the measurement processor 112 may count that period as “time of not writing”. The upper limit may be individually set for each axis direction or rotation direction, may be the same value in the three-axis directions, or may be the same value in all the rotation directions.

Alternatively, in Step S3, the measurement processor 112 may compare a mean, median, or maximum value, etc. of the speed (absolute value thereof) or displacement (absolute value thereof) of the motion of the writing implement P in the target period with a predetermined upper limit, and if the former is equal to or larger than or exceeds the latter, may count that period as “time of not writing” during which the user is not performing the act of writing. The speed or displacement of the motion of the writing implement P in the period can be calculated on the basis of the acceleration and/or angular velocity detected via the acceleration sensor 124 in the same period.

The number of periods of “time of writing”, counted through Steps S1 to S5, corresponds to the amount of writing in the act of writing performed by the user using the writing implement P. The total value of the number of periods of “time of writing” and the number of periods of “time of not writing” counted corresponds to the total length of the time during which the user had been holding the writing implement P in his/her hand, including the time other than the act of writing. The measurement processor 112 stores, in the storage 12, the number of periods of “time of writing” corresponding to at least the amount of writing. The measurement processor 112 also stores, in the storage 12, the number of periods of “time of not writing” and/or the total value of the number of periods of “time of writing” and the number of periods of “time of not writing”.

In addition, the measurement processor 112 evaluates, for each period determined to be the “time of writing”, the magnitude of the total of the absolute values (e.g., √(x2+y2) or √(X′2+Y′2)) of the accelerations of the respective frames included in that period, that is, the magnitude of the sum of the absolute values of the ten accelerations, in a step-by-step manner, for example, in five stages (Step S6). In other words, the measurement processor 112 determines within which one of the five rank categories the total of the absolute values of the accelerations exceeding the determination threshold in Step S3 falls. This means that the speed of strokes of the writing implement P in the period is evaluated in five stages. The measurement processor 112 then counts the frequency of occurrence of the five-stage evaluation (Step S7). For example, if the total of the absolute values of the accelerations in a certain period falls within the range of C-rank, the value of the frequency of occurrence of C-rank is increased by 1.

The frequency of occurrence of each rank counted through Steps S6 and S7 suggests the writing speed in the act of writing performed by the user using the writing implement P. The measurement processor 112 stores, in the storage 12, a histogram of the frequency of occurrence of each rank, that is, values of the frequency of occurrence of A-rank, the frequency of occurrence of B-rank, . . . , and the frequency of occurrence of E-rank. Assuming that the number of periods counted as “time of writing” is 500, the total value of the frequency of occurrence of A-rank, the frequency of occurrence of B-rank, . . . , and the frequency of occurrence of E-rank is 500. When the writing speed of the user is evaluated, the rank with the highest frequency of occurrence, or a mean, median, or the like obtained by totaling for all ranks the product of the frequency of occurrence of each rank and a rank score value (e.g., 5 for A-rank, 4 for B-rank, . . . , and 1 for E-rank) can be used as an index for evaluation.

The controller 11 iteratively executes Steps S1 to S7 described above to acquire the data related to the act of writing by the user using the writing implement P, that is, the amount of writing and the writing speed in the act of writing, and to store and retain it in the storage 12. The output value of the acceleration sensor 124 obtained in the period determined as “time of not writing” in Step S2 or S3, and the amount of writing or writing speed calculated on the basis of the output value are not acquired as the data related to the act of writing (that is, not counted as “time of writing” and not subjected to the five-stage evaluation for writing speed. The count of “time of not writing” is not the amount of writing and does not correspond to the data related to the act of writing), and not stored and retained.

Note that the measurement processor 112 may calculate and then store and retain, as the amount of writing in the act of writing, the integrated value of the displacement of the tip of the writing implement P in the period determined as “time of writing”. The measurement processor 112 may also calculate and then store and retain, as the writing speed in the act of writing, a mean or median of the speed of the motion of the tip of the writing implement P in the period determined as “time of writing”, a value obtained by dividing the integrated value of the displacement of the tip of the writing implement P in the period determined as “time of writing” by the number of periods of “time of writing” (in the end, the displacement of the tip of the writing implement P per unit time), or the frequency of occurrence of each rank when any one of the above values is evaluated in steps.

Note that the writing apparatus 1 is configured to be attachable to the writing implement P in any orientation of the front-rear direction. For example, the writing apparatus 1 may be attached to the writing implement P such that the LED 14 is located on the tip side of the writing implement P (the writing surface side), and the writing apparatus 1 may be attached to the writing implement P such that the LED 14 is located on the rear end side (opposite to the writing surface) of the writing implement P. The controller 11 is configured to be capable of appropriately determining the act of writing even when the writing apparatus 1 is attached in any orientation. For example, the controller 11 determines not the front-rear direction of the writing apparatus 1 but the angle of the writing apparatus 1, making it possible to appropriately determine the act of writing irrespective of the front or rear orientation.

The transmission processor 113 of the writing apparatus 1 transmits the data related to the act of writing, obtained by the user using the writing implement P, which has been detected by the acquisition processor 111 and the measurement processor 112 and stored and retained in the storage 12, to the operation terminal 2 through the communication unit 15.

### Operation Terminal 2

As shown in FIG. 16, the operation terminal 2 includes a controller 21, a storage 22, an operation display 23, a communication unit 24, and the like. The operation terminal 2 is, for example, an information processing apparatus such as a smartphone, a cellular phone, a smartwatch, a tablet terminal, or a personal computer.

The communication unit 24 is a communication interface for connecting the operation terminal 2 to a communication network wirelessly and executing data communication, according to a predetermined communication protocol, with an external apparatus such as the writing apparatus 1 via the communication network. For example, the communication unit 24 includes a wireless transceiver for wireless communication via Bluetooth (registered trademark), a wireless LAN, a cellular phone network, a WiMAX network, etc., or an RFID card or a chip.

The operation display 23 is a user interface including a display such as a liquid crystal display or organic EL display that displays various operation screens, and an operation unit such as a mouse, keyboard, or touch panel that receives the operation.

The storage 22 is a nonvolatile storage such as an HDD, SSD, or flash memory that stores various types of information. For example, the storage 22 stores a control program such as a written information display program for causing the controller 21 to execute a written information display processing (see FIGS. 18A and 18B) to be described below. For example, the written information display program is non-transiently recorded on a computer-readable recording medium such as a CD or a DVD, read by a reader (not shown) such as a CD drive or DVD drive included in the operation terminal 2, and stored in the storage 22. In addition, the written information display program may be downloaded from a cloud server to the operation terminal 2 and stored in the storage 22. The written information display program is, for example, a writing application that manages and displays information based on the data related to the act of writing. For example, the user can download the writing application into the operation terminal 2 and use the writing application.

The controller 21 includes control devices such as a CPU, a ROM, or a RAM. The CPU is a processor that executes various types of arithmetic processing. The ROM is a nonvolatile storage in which control programs such as the BIOS and the OS for causing the CPU to execute various types of processing are stored in advance. The RAM is a volatile or nonvolatile storage that stores various types of information, and is used as a temporary storage memory (work area) for the CPU to execute various types of processing. The controller 21 then executes various control programs stored in advance in the ROM or the storage 22 by the CPU, thus controlling the operation terminal 2.

Specifically, the controller 21 includes various processors such as a reception processor 211 and a display processor 212. Note that the controller 21 functions as the various processors by the CPU executing various types of processing according to the written information display program. In addition, some or all of the processors may be configured by electronic circuits. Note that the written information display program may be a program for causing one or more processors to function as the processors described above.

The reception processor 211 receives the data related to the act of writing, which is transmitted from the writing apparatus 1. In addition, the reception processor 211 stores and retains the received data in a predetermined storage area of the storage 22.

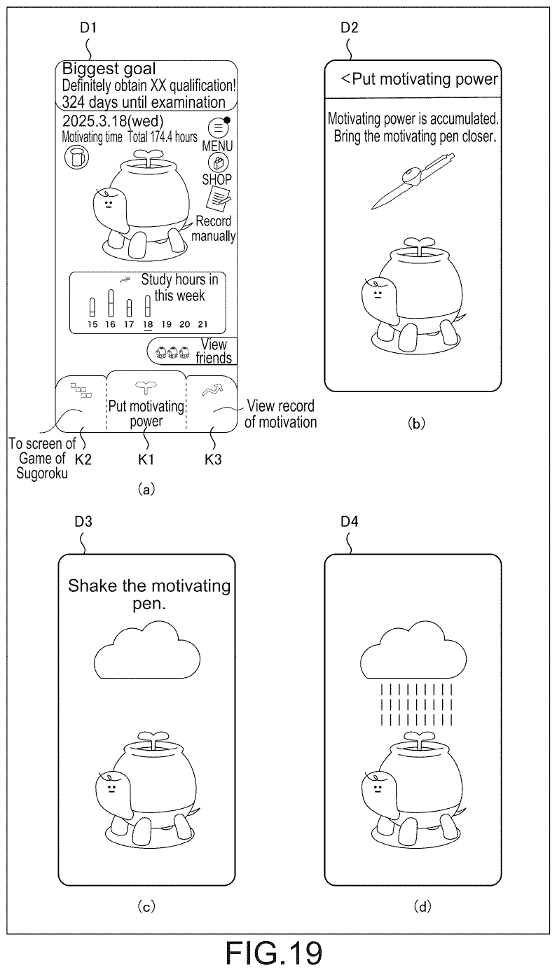

For example, when the user starts the writing application of the operation terminal 2 and performs an operation of shaking the writing apparatus 1 close to the operation terminal 2 (see (b) of FIG. 19), data exchange between the writing apparatus 1 and the operation terminal 2 starts. This operation imitates, while regarding the amount of writing in the act of writing that has been performed by the user with the writing implement P as a kind of energy or power, the behavior of a user who pours that energy or power accumulated in the writing implement P through the act of writing into the operation terminal 2.

The display processor 212 causes the operation display 23 to display various screens on the basis of the data related to the act of writing, which has been received by the reception processor 211. For example, the display processor 212 causes the operation display 23 to display a screen showing a progress status of learning, or the like. Specific examples of the display screen will be described later.

In addition, for example, if a plurality of main body lower parts 1B with different widths W1 are prepared, and when the user selects a writing object, the display processor 212 may present a main body lower part 1B suitable for the selected writing object to the user. For example, a writing object and identification information of the main body lower part 1B suitable for the writing object are associated with each other and registered in the storage 22. When the user selects a writing object to be used on a setting screen (not shown), the display processor 212 displays the identification information of the main body lower part 1B corresponding to that writing object on the setting screen.

As another embodiment of the writing system 10, the writing application may be a web application. In this case, the user can access a web site and use the writing application through the browser processing on the operation terminal 2. In addition, in this case, a cloud server may include the reception processor 211 and the display processor 212 to perform each processing on the writing application.

### Written Information Display Processing

FIGS. 18A and 18B show procedures of processing for transmitting and receiving the data related to the act of writing and for displaying the written information by the transmission processor 113 of the writing apparatus 1 and the reception processor 211 of the operation terminal 2. After a preliminary step for data transmission and reception is prepared (Step S8), the transmission processor 113 of the writing apparatus 1 acquires the angular velocities [θ, φ, Ψ] of rotation around the three axes of the writing implement P via the acceleration sensor 124 at every predetermined time, that is, every frame (Step S9).

The branch determination in Step S8 is “true”, for example, when the user operates a predetermined button, switch, or the like (e.g., operation button 13) mounted on the writing apparatus 1 itself. Alternatively, it is “true” when the user performs a specific operation via the operation unit of the operation terminal 2, and a signal or information indicating that the specific operation has been performed is transmitted from the operation terminal 2 to the writing apparatus 1 and then received by the writing apparatus 1. Note that the operation of shaking the writing implement P may be naturally performed during writing. Therefore, Step S8 is intended to prevent the data transmission from the writing apparatus 1 to the operation terminal 2 from being started during writing even though the user does not intend to do so.

The angular velocities acquired in Step S9 may be raw values output by the acceleration sensor 124, or may be values obtained by performing some filter processing on the raw values output by the acceleration sensor 124.

The transmission processor 113 of the writing apparatus 1 transmits a time series of the angular velocities [θ, φ, Ψ] of rotation of the writing implement P, detected via the acceleration sensor 124 at every predetermined time, in any numerical format such as Euler angles or quaternions, to the operation terminal 2 (Step S10).

The reception processor 211 of the operation terminal 2 receives the time series of the angular velocities of rotation of the writing implement P at every predetermined time, which is provided from the writing apparatus 1 (Step S11). On the basis of the time series, it is determined whether or not the user has performed an operation of shaking the writing implement P in the vicinity of the operation terminal 2 (Step S12). If it is determined that the user has performed an operation of shaking the writing implement P in the vicinity of the operation terminal 2, the reception processor 211 transmits a signal or information indicating that effect to the writing apparatus 1 (Step S13).

Under the condition that the signal or information provided from the operation terminal 2 is received (Step S14), the transmission processor 113 of the writing apparatus 1 starts transmitting the data stored and retained in the storage 12 to the operation terminal 2 (Step S15).

Steps S10 to S14 described above are for the operation terminal 2 determining and confirming that the user has performed the operation of shaking the writing implement P with the user's hand in the vicinity of the operation terminal 2. However, the writing apparatus 1 may determine whether or not such an operation has been performed on the basis of the time series of the angular velocities of rotation of the writing implement P at every predetermined time, and under the condition that the operation described above has been performed, may transmit the data to the operation terminal 2 (Step S15). If the writing apparatus 1 determines whether or not the operation described above has been performed, the procedure of Steps S10 to S14 can be omitted.

The data transmitted to the operation terminal 2 by the writing apparatus 1 in Step S15 contains the number of periods of “time of writing” indicating the amount of writing, and the frequency of occurrence of each rank in the five-stage evaluation indicating the speed of writing, which are the data related to the user's act of writing, as well as the number of periods of “time of not writing” and/or the total value of the number of periods of “time of writing” and the number of periods of “time of not writing”.

The reception processor 211 of the operation terminal 2 receives the data provided from the writing apparatus 1 (Step S16) and stores the data in the storage 22. At that time, the operation terminal 2 may add the number of periods of “time of writing” newly received to the number of periods of “time of writing” that has been received in the past and then stored and retained in the storage 22. In addition, the operation terminal 2 may add a histogram of the frequency of occurrence of each rank newly received to a histogram of the frequency of occurrence of each rank in the five-stage evaluation of the writing speed that has been received in the past and stored and retained. Besides, the operation terminal 2 may add the number of periods of “time of not writing” or the total value of the number of periods of “time of writing” and the number of periods of “time of not writing”, which is newly received, to the number of periods of “time of not writing” or the total value of the number of periods of “time of writing” and the number of periods of “time of not writing”, which has been received in the past and stored and retained.

The data transmission and reception in Steps S15 and S16 may be completed as quickly as possible, but it may be also possible to apply such an effect that as the value of data stored and retained in the writing apparatus 1 becomes larger or as the amount of data becomes larger, the time required to complete the data transmission and reception becomes longer. In more detail, the transmission processor 113 of the writing apparatus 1 and the reception processor 211 of the operation terminal 2 complete the data transmission and reception under the condition that the length of time during which the user keeps the writing implement P close to the operation terminal 2 exceeds a threshold, and set the threshold to be larger (longer) as the number of periods of “time of writing” stored and retained in the writing apparatus 1 becomes larger, or set the threshold to be larger as the frequency of occurrence of each rank in the five-stage evaluation of the writing speed that has been stored and retained in the writing apparatus 1 becomes larger. In other words, as the energy or power accumulated in the writing implement P by the user through the act of writing becomes larger, it takes a longer time required to pour all of that energy or power into the operation terminal 2.

Until the data transmission and reception is completed, that is, while the user keeps the writing implement P close to the operation terminal 2 (at a point in time when the length of time during which the user keeps that state does not reach a threshold), as a function of the reception processor 211 of the operation terminal 2, it is also desirable to output information for making the user aware that the transmission and reception processing is in progress, that is, making the user aware that the user should still maintain that state, in a manner that appeals to the user's visual or auditory sense. For example, during the transmission and reception, a moving image of rainfall may be displayed, or a sound effect such as the sound of rainfall may be output.

In addition, if the data transmission and reception is not instantaneously completed as described above, during the data transmission and reception, it may also be possible to perform processing such as gradually changing (gradually decreasing) the data value stored in the storage 12 of the writing apparatus 1, particularly, the number of periods of “time of writing” or the value of the frequency of occurrence of each rank in the five-stage evaluation of the writing speed, as well as gradually changing (gradually increasing) the data value stored in the storage 22 of the operation terminal 2, particularly, the number of periods of “time of writing” or the value of the frequency of occurrence of each rank in the five-stage evaluation of the writing speed.

Before the length of time during which the user keeps the writing implement P close to the operation terminal 2 exceeds a threshold, if the user stops maintaining that state, the data transmission and reception itself may be cancelled, that is, the data stored in each of the writing apparatus 1 and the operation terminal 2 may be set to the one before the data transmission and reception is started (or may be restored to the data before the data transmission and reception). Alternatively, if the processing of gradually changing the data value stored in each of the writing apparatus 1 and the operation terminal 2 is performed during the data transmission and reception, the data value at the point in time when the user stops maintaining the above-mentioned state may be stored and retained in the writing apparatus 1 and the operation terminal 2. The determination as to whether or not the user keeps the writing implement P close to the operation terminal 2 during the data transmission and reception may be made in a similar manner that it is determined whether or not the user performs an operation of shaking the writing implement P in the vicinity of the operation terminal 2 as a condition to start the data transmission and reception. The determination result may be notified (transmitted) from the operation terminal 2 to the writing apparatus 1 after the determination is performed by the operation terminal 2, or the determination may be made by the writing apparatus 1 itself.

After the data transmission and reception between the writing apparatus 1 and the operation terminal 2 (Steps S15 and S16) is completed, the writing apparatus 1 deletes the transmitted data, which has been stored and retained in the storage 12 so far, from the storage 12, that is, resets the number of periods of “time of writing”, the number of periods of “time of not writing”, and the frequency of occurrence of each rank in the five-stage evaluation of the writing speed to zero (Step S17).

The transmission processor 113 of the writing apparatus 1 and the reception processor 211 of the operation terminal 2 shut down the communication therebetween, that is, stop transmitting wireless signals to each other during the periods other than the period of the data transmission and reception in Steps S8 to S17 described above, thereby reducing power consumption.

The display processor 212 of the operation terminal 2 outputs information corresponding to the data related to the act of writing by the user using the writing implement P, which has been received from the writing apparatus 1 and stored in the storage 22, in a manner that appeals to the user's visual or auditory sense.

Next, a specific example of the screen displayed by the display processor 212 will be described. (a) of FIG. 19 is an example of a home screen D1. For example, when the user starts the writing application on the operation terminal 2, the display processor 212 displays the home screen D1. The display processor 212 displays on the home screen D1 a goal set by the user, a study time corresponding to “time of writing” per day, a weekly graph showing the study time per week as a graph, and the total study time up to the present (“total motivating time”). If such information is displayed, the user can increase his/her daily awareness of the goal and study, and can be aware of daily changes.

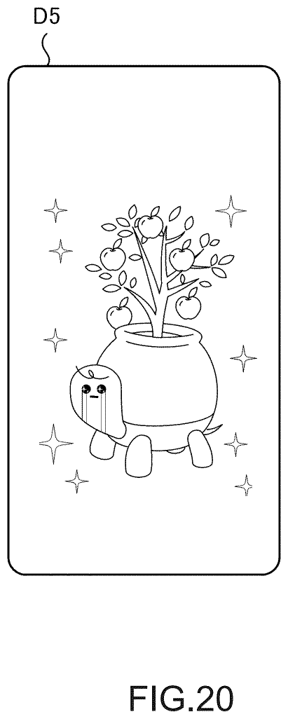

When the user pours the energy or power accumulated in the writing implement P through the act of writing into the operation terminal 2, the user presses an operation button K1 on the home screen D1. When the operation button K1 is pressed, the display processor 212 displays a screen D2 shown in (b) of FIG. 19. When the user confirms the screen D2 and moves the writing implement P, to which the writing apparatus 1 is attached, close to the operation terminal 2, the display processor 212 displays a screen D3 shown in (c) of FIG. 19. In addition, the display processor 212 changes, on the screen D3, the color of cloud according to the accumulated time corresponding to the amount of writing accumulated in the writing apparatus 1. Additionally, when the user confirms the screen D3 and performs the operation of shaking the writing implement P, the display processor 212 displays a screen D4 shown in (d) of FIG. 19, which shows a moving image of rainfall. In addition, the display processor 212 changes the color of rain according to the amount of writing. Note that when the user taps the cloud, the display processor 212 may display a moving image of rainfall. After that, the display processor 212 displays a screen D5 shown in FIG. 20 and shows a moving image of a tree in a pot, growing and producing fruit (apples) on the tree. In addition, the display processor 212 also changes the number of apples according to the accumulated time. For example, the display processor 212 displays more apples as the accumulated time becomes longer.

In such a manner, on the basis of the amount of writing (the accumulated value thereof) in the act of writing that has been performed by the user so far (e.g., the act of writing after pouring the energy or power accumulated in the writing implement P into the operation terminal 2 through the previous connection to the operation terminal 2), the display processor 212 generates or selects and displays an image of a tree that grows more as the amount of writing increases, the image being information that visually indicates the amount of writing. At that time, it is also possible to generate or select and output sound information that is different in tone, melody, volume of sounds, etc., according to the amount of writing that has been performed by the user so far.

The amount of writing can be said to be the outcome of the learning that the user has performed so far. Presenting the amount of writing to the user in a timely manner makes it possible to introduce a game element to the act of writing with the writing implement P and maintain and improve the motivation for learning.

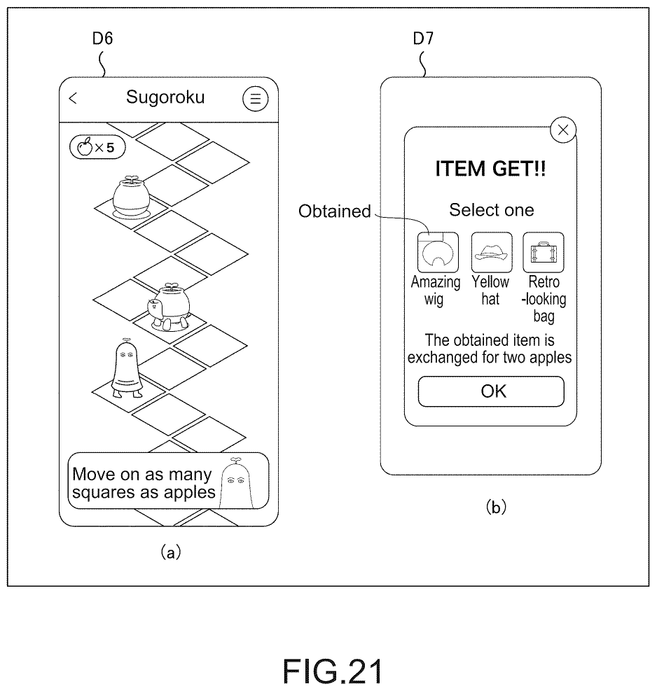

As another function to further maintain and improve the motivation for learning, for example, a sugoroku (snakes and ladders) function may be provided. For example, when the user presses an operation button K2 of the home screen D1 (see (a) of FIG. 19), the display processor 212 displays a sugoroku screen D6 shown in (a) of FIG. 21. The display processor 212 moves, on the sugoroku screen D6, an icon (pot icon) forward by the number of apples acquired in accordance with the accumulated time. In addition, if another item is present in a square to which the icon is moved, that item can be acquired. (b) of FIG. 21 shows a screen displayed when the item can be acquired (item screen D7). The item is an item for changing a pot, a mask, the color of skin, a background, and the like of the user's icon (pot icon), and the user can customize his/her icon using the acquired item. The image of the customized icon is reflected on the home screen D1 (see (a) of FIG. 19) and the like. Note that the display processor 212 may display an item extracted at random among a plurality of items in a predetermined square of the sugoroku screen D6. In addition, the display processor 212 may display that item in a square determined at random among a plurality of squares of the sugoroku screen D6.

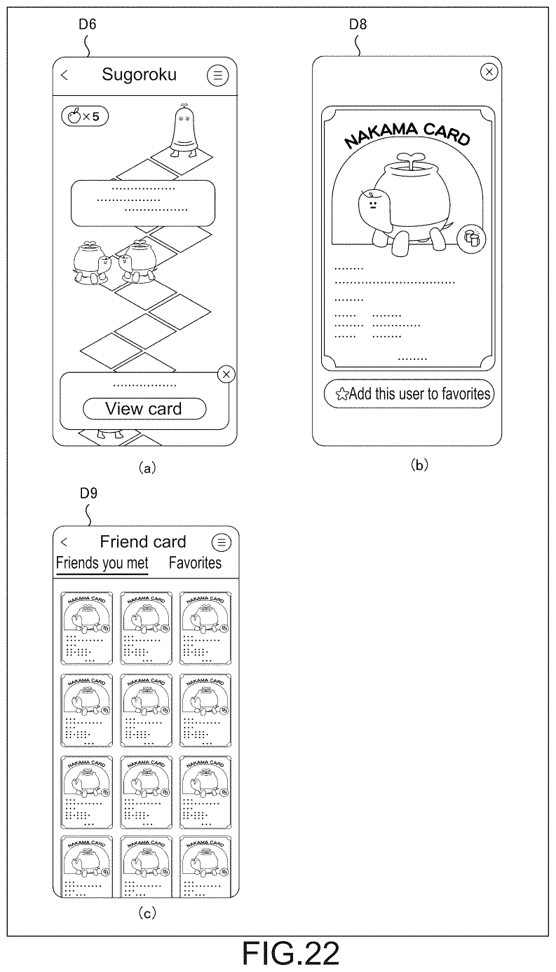

In addition, as another function to further maintain and improve the motivation for learning, a function of acquiring information of another user may be provided. For example, as shown in (a) of FIG. 22, if another user's icon is present in a square to which the icon is moved on the sugoroku screen D6, the display processor 212 displays a friend card screen D8 as shown in (b) of FIG. 22. The display processor 212 displays an icon (pot icon) corresponding to another user who is using the writing application in any square on the sugoroku screen D6. If another user's icon is present in a square to which the user's icon is moved, the display processor 212 displays the friend card screen D8 and displays information related to the learning of the other user (goal, learning progress status, learning advice, etc.) on the friend card screen D8. For example, the display processor 212 displays the card of another user on the friend card screen D8, and displays his/her learning goal, progress status, and the like on the front side of the card, as well as advice (tips) for learning, reasons for learning, and the like on the back side of the card. This allows the user to gain new insights into other users' learning methods, which leads to an improvement in motivation.

Note that the display processor 212 may display, for example, another user related to the learning contents of the user, or another user who sets the same goal (sets the goal for acquisition of the same qualification) on the sugoroku screen D6. In addition, the display processor 212 may display, on the sugoroku screen D6, another user having a study time equal to the study time of the user. When the user performs a registration operation on the friend card screen D8, the display processor 212 adds and registers the information of the other user as favorites. The display processor 212 can display a list of other users (friends) the user has met by the sugoroku function and a list of other users registered as favorites as shown in a screen D9 shown in (c) of FIG. 22.

The display processor 212 may display the items and other users' icons described above in predetermined squares on the sugoroku screen D6 at timing set in advance (e.g., every 2 days, every 3 days, or every 2 weeks). In addition, the display processor 212 may change the frequency of appearance of the items and other users' icons described above in accordance with the accumulated time. For example, the frequency of appearance may be set higher in the initial period when learning has started, and may be set lower as the learning period becomes longer (as the accumulated time becomes longer).

In addition, the user can also check the record of the learning. For example, when the user presses an operation button K3 on the home screen D1 (see (a) of FIG. 19), the display processor 212 display a calendar (not shown) showing the days on which the user have studied in a distinguishable manner. In addition, the display processor 212 can display a graph of study time in units of days (time zones), weeks, months, and years, and can display a graph of study time for each goal (e.g., qualification to be acquired). Additionally, the display processor 212 can add the time, during which the writing apparatus 1 is not being used, to the study time and display that time. For example, the user can add the time spent in learning (e.g., time during reading a study book) to the study time even if the user does not activate and use the writing apparatus 1. Note that the function of adding the study time without activating the writing apparatus 1 may be provided to a specific user (e.g., a user of a paid plan, a user who has studied for more than a predetermined time, etc.).

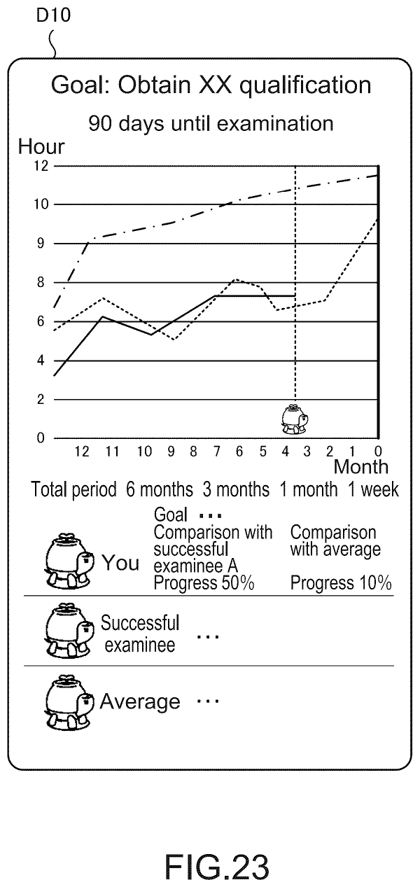

In addition, the display processor 212 may also display the learning records in a manner that allows comparison with other users who have set the same goal. For example, on a screen D10 shown in FIG. 23, the display processor 212 compares and displays the study time of the user, the study time of another specific user aiming to acquire the same qualification, and the average study time of all users aiming to acquire the same qualification. In addition, the display processor 212 displays the user's progress status of study in comparison with the study schedules of other users who have acquired the qualification. Additionally, the display processor 212 may also display a ranking of a plurality of users who have set the same goal (e.g., a ranking in order of the amount of study time). This allows the user to check the learning statuses of other users and thus maintain and improve the motivation.

### Other Embodiments

The writing system 10 according to the present invention is not limited to the embodiment described above and may be the following embodiments.

### Calibration Function 1

The writing system 10 may have a function (calibration function) of setting a determination range for determining whether or not the change in acceleration and angular velocity corresponding to the motion (movement) of the writing implement P (writing apparatus 1) corresponds to the “time of writing” during which the user is performing the act of writing or the “time of not writing” during which the user is not performing the act of writing.

The writing apparatus 1 according to this embodiment has a configuration applicable to various writing implements (writing objects), and thus it is conceivable that the position to which the writing apparatus 1 is attached differs depending on each user. For example, there are a user who performs the act of writing with the writing apparatus 1 being attached to the tip side of the writing implement P (writing surface side) as shown in FIG. 2, and a user who performs the act of writing with the writing apparatus 1 being attached to the rear end side (opposite to the writing surface) of the writing implement P.

In such a manner, when the position to which the writing apparatus 1 is attached differs, the amount of movement of the writing apparatus 1 changes, and thus detected values differ even when the same act of writing is performed, resulting in variations in determination results of the act of writing.

In this regard, the writing system 10 may have a calibration function for suppressing variations in determination results due to the position to which the writing apparatus 1 is attached. For example, when the user selects “MENU” on the home screen D1 (see (a) of FIG. 19) and presses a “calibration” button (not shown), the operation terminal 2 enters a calibration mode. For example, the operation terminal 2 prompts the user to attach the writing apparatus 1 to the writing implement P and perform test writing. The operation terminal 2 may set the time of test writing to a predetermined time, or may set the amount of test writing to a predetermined amount.

The operation terminal 2 outputs an instruction to execute the calibration processing to the writing apparatus 1. When starting the calibration processing, the writing apparatus 1 sets a threshold for determining whether or not the user is performing the act of writing on the basis of the data detected in the period of test writing, i.e., the period during which the user is performing the act of writing (“time of writing”). The operation terminal 2 may display the status of the calibration processing (the status of the above-mentioned predetermined time or the above-mentioned amount of writing, the setting status of the threshold, and the like). Thus, for example, in the writing apparatus 1 of the user who performs the act of writing by attaching the writing apparatus 1 to the tip side (writing surface side) of the writing implement P as shown in FIG. 2, the threshold is set to be low because the amount of movement of the writing apparatus 1 tends to be small. On the other hand, in the writing apparatus 1 of the user who performs the act of writing by attaching the writing apparatus 1 to the rear end side (opposite to the writing surface) of the writing implement P, the threshold is set to be high because the amount of movement of the writing apparatus 1 tends to be large. In particular, when the writing apparatus 1 is attached to a position distant from the tip of the writing implement P (rear end side), the amount of movement of the tip of the writing implement P tends to be larger than the amount of movement of the writing apparatus 1. In such a manner, the amount of change (the amount of movement) of the tip of the writing implement P and the amount of movement of the writing apparatus 1 have a correlation corresponding to the positional relationship and distance between the tip of the writing implement P and the writing apparatus 1, and thus the above-mentioned threshold is adjusted to suppress the variations in the determination result due to the position to which the writing apparatus 1 is attached.

In such a manner, setting the above-mentioned threshold for each writing apparatus 1 makes it possible to appropriately determine the act of writing.

Note that if a plurality of users use a single writing apparatus 1, it may be possible to execute the calibration processing for each user and set a threshold for each user. In this case, the writing apparatus 1 and the operation terminal 2 store the threshold in association with each user. When the writing apparatus 1 is used, the user inputs his/her user ID to the operation terminal 2, the operation terminal 2 transmits the user ID to the writing apparatus 1, and the writing apparatus 1 sets a threshold corresponding to the received user ID.

### Calibration Function 2

As another embodiment of the calibration function, the writing system 10 may set a threshold in accordance with the writing object or the type of writing object. For example, the writing apparatus 1 can be attached to various writing implements P such as a mechanical pencil, a ballpoint pen, a pencil, and an electronic pen (touch pen, stylus pen, etc.). A coefficient of friction with the writing surface differs depending on the type of writing implement P, and thus vibration applied to the writing apparatus 1 also differs. Accordingly, when the writing apparatus 1 is attached to different writing objects, the amount of movement of the writing apparatus 1 changes, and thus detected values differ even when the same act of writing is performed, resulting in variations in determination results of the act of writing.

In this regard, the writing system 10 may have a calibration function for suppressing variations in determination results due to an object to which the writing apparatus 1 is attached (writing object). For example, when the user selects “MENU” on the home screen D1 (see (a) of FIG. 19) and presses a “calibration” button (not shown), the operation terminal 2 enters a calibration mode. The operation terminal 2 prompts the user to display a screen to select a writing object (mechanical pencil, ballpoint pen, pencil, electronic pen (touch pen, stylus pen, etc.)) and to select a writing object. In addition, the operation terminal 2 prompts the user to attach the writing apparatus 1 to the writing implement P selected by the user to perform test writing.

When starting the calibration processing, the writing apparatus 1 sets a threshold for determining whether or not the user is performing the act of writing on the basis of the data detected in the period of test writing, i.e., the period during which the user is performing the act of writing (“time of writing”). In addition, the writing apparatus 1 stores the threshold in association with the type of writing object selected by the user. When the user changes the type of writing object to which the writing apparatus 1 is attached, the user executes the calibration processing again and adds a threshold corresponding to the type of writing object for registration. If the thresholds for multiple types of writing object are registered, the user selects a writing object to be used in the operation terminal 2 when the writing apparatus 1 is used. Thus, the writing apparatus 1 sets a threshold on the basis of the identification information of the writing object that is acquired from the operation terminal 2.

In such a manner, setting the above-mentioned threshold corresponding to the writing object to which the writing apparatus 1 is attached makes it possible to appropriately determine the act of writing.

As another embodiment, the writing apparatus 1 may identify a writing object on the basis of the friction coefficient and vibration detected in response to the act of writing. In this case, the writing apparatus 1 identifies a writing object on the basis of the friction coefficient and vibration in a predetermined period immediately after the user starts writing, acquires the threshold corresponding to the identified writing object among the registered thresholds, and sets the threshold as a determination threshold. This saves the user the trouble of selecting the writing object to be used in the operation terminal 2.

In addition, as another embodiment, if the writing apparatus 1 has a function of identifying the type of writing object, the operation terminal 2 may acquire information of the type of writing object used by the user from the writing apparatus 1. This makes it possible to grasp and analyze the usage state of the writing apparatus 1, such as on what kind of writing object the writing apparatus 1 is used, for example, when a management server (cloud server) acquires information of the type of writing object from a plurality of operation terminals 2.

In addition, as another embodiment, the writing apparatus 1 may set the threshold by using the [Calibration Function 1] and [Calibration Function 2] described above together. This makes it possible to more appropriately determine the act of writing.

In addition, in the [Calibration Function 1] and [Calibration Function 2] described above, the writing system 10 may determine the status of the act of writing on the basis of the detection value acquired in the calibration processing and notify the user of the determination result. For example, if the writing speed of the user is significantly different from the speed acquired in the calibration processing, the writing apparatus 1 or the operation terminal 2 may be used by a different user from the registered user, and the act of writing of the original user may not be determined appropriately. Therefore, the writing apparatus 1 or the operation terminal 2 notifies the user of an error, etc.

### Other Setting Methods for Measurement Start Timing

In the embodiment described above, the measurement of the acceleration and angular velocity (measurement of “time of writing” and “time of not writing”) starts when the power supply of the writing apparatus 1 is turned on. Accordingly, for example, if there is a time interval between when the user turns on the power supply of the writing apparatus 1 and when the user starts writing, that time is counted as “time of not writing” during which the user is not performing the act of writing. Normally, it takes some time from turning on the power supply of the writing apparatus 1 to starting writing, and if this time is determined as the time during which the user is not performing the act of writing, the user may feel dissatisfied. In this regard, the writing apparatus 1 may start measuring the act of writing when a predetermined condition is met after the power supply is turned on. For example, the writing apparatus 1 starts the measurement at the timing when the user holds the writing implement P after the power supply is turned on, or at the timing when the user starts writing with the writing implement P after the power supply is turned on. This makes it possible to determine the act of writing more appropriately.

### Other Setting Methods for Determination Threshold of Act of Writing

The writing system 10 may set a threshold of the act of writing on the basis of various conditions. Note that the threshold is not limited to a threshold for determining the act of writing, but may be a threshold for determining the color of the LED 14 to be lit or a threshold for determining the number of apples displayed on the screen D5 shown in FIG. 20.

For example, the user may set the threshold. For example, a user who wants to put a load on him/herself can set a higher threshold on a setting screen (not shown) of the operation terminal 2, which makes it difficult to count the time as “time of writing”. For example, a user who does not want to put a load on him/herself can set a lower threshold on the setting screen of the operation terminal 2, which makes it easier to count the time as “time of writing”.

In addition, for example, the writing apparatus 1 may set the threshold in accordance with the target difficulty level set by the user. For example, the writing apparatus 1 sets the threshold to a higher value when the user sets a goal to acquire a difficult qualification. The difficulty level may be a difficulty level generally available for each qualification.

In addition, for example, the writing apparatus 1 may set the threshold in accordance with the attribute of the user. For example, the writing apparatus 1 sets the threshold to a lower value if the user is a child, and sets the threshold to a higher value if the user is an adult. Note that the writing apparatus 1 can identify the attribute of the user on the basis of the user information (age, gender, occupation, etc.) registered on the operation terminal 2, for example.

### Other Structures of Writing Apparatus 1

In the embodiment described above, the writing apparatus 1 is configured to be attachable to and detachable from the side surface of the writing implement P. As another embodiment, the writing apparatus 1 may be of a cap type that covers the rear end of the writing implement P. Thus, the position of the writing apparatus 1 is limited regardless of the type of writing object, which eliminates the need for the calibration processing.

In addition, in the embodiment described above, the main body lower part 1B of the writing apparatus 1 has a configuration that holds the side surface of the writing implement P, but as another embodiment, the main body lower part 1B may be formed in a cylindrical shape. In this case, the user can attach the writing apparatus 1 to the writing implement P by inserting the writing implement P into the cylindrical part of the main body lower part 1B.

### Other Embodiments of Measurement Processing

The writing apparatus 1 having the configurations described above may have a configuration that executes the following measurement processing.

Conventional systems have detected the amount of movement of a writing implement corresponding to the user's act of writing to acquire and manage data (written information) such as handwriting. In the conventional system, the act of writing is determined on the basis of the amount of movement of the writing implement (object to be measured), and thus it is difficult to accurately grasp the usage state of the writing implement because it is not possible to determine whether the user is actually writing or just moving the writing implement without writing. On the other hand, the writing system according to the present invention can accurately grasp the usage state of the writing implement (object to be measured) by the user. The specific configuration of the writing system 10 to achieve the above effects will be described below. Note that, in the following, the description of the same configurations as those in the embodiment described above will be omitted as appropriate.

The acquisition processor 111 of the writing apparatus 1 (see FIG. 16) acquires an acceleration of movement corresponding to the use of the writing implement P by the user. Note that the acquisition processor 111 may acquire an angular velocity in addition to the acceleration as in the embodiment described above. In addition, the acquisition processor 111 acquires an angle of the writing implement P in the usage state by the user. For example, the acquisition processor 111 acquires the angle (0 to 90 degrees) of the Z-axis, which is the axis of the writing implement P, with respect to the writing surface. The acquisition processor 111 acquires the acceleration and angle of the writing implement P from the acceleration sensor 124.

The measurement processor 112 measures time corresponding to the usage state of the writing implement P on the basis of the acceleration and angle of the writing implement P acquired by the acquisition processor 111. Note that the measurement processor 112 may count the time for every predetermined number of consecutive frames (1 period), as in the embodiment described above.

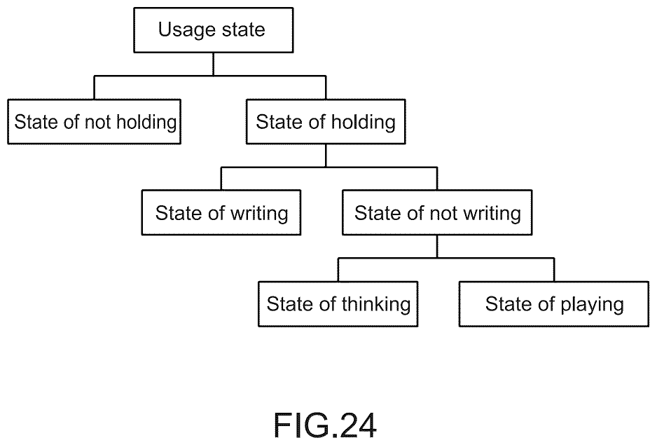

Here, “the usage state of the writing implement P” includes a state in which the user is holding the writing implement P in hand, a state in which the user is not holding the writing implement P in hand, a state in which the user is holding the writing implement P in hand and writing, a state in which the user is holding the writing implement P in hand but not writing, a state in which the user is holding the writing implement P in hand and thinking, a state in which the user is holding the writing implement P in hand and playing with it, and the like. FIG. 24 shows a conceptual diagram of the usage state. As shown in FIG. 24, the usage state is classified into “a state of holding the writing implement P” and “a state of not holding the writing implement P”. In addition, “the state of holding the writing implement P” is classified into “a state of writing with the writing implement P” and “a state of not writing with the writing implement P”. In addition, “the state of not writing with the writing implement P” is classified into “a state of thinking” and “a state of playing (state of not thinking)”.

The measurement processor 112 measures a time corresponding to each usage state described above. For example, the measurement processor 112 measures a time during which the user is holding the writing implement P in hand (first time T1), a time during which the user is not holding the writing implement P in hand (fifth time T5), a time during which the user is holding the writing implement P in hand and writing (second time T2), a time during which the user is holding the writing implement P in hand and thinking (third time T3), a time during which the user is holding the writing implement P in hand and playing with it (fourth time T4), and the like.

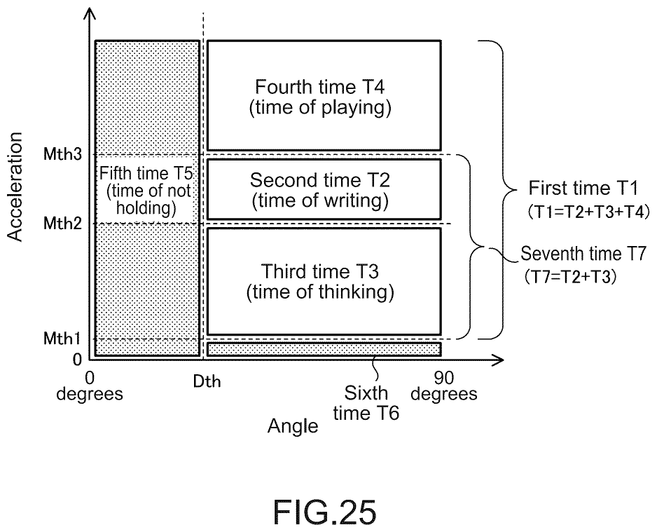

Specifically, the measurement processor 112 counts the first time T1 to the fifth time T5 separately on the basis of the acceleration and the angle of the writing implement P. FIG. 25 is a graph showing a relationship between the acceleration and angle, and each of the times described above. For example, the measurement processor 112 counts the time during which the acceleration of the writing implement P exceeds a first threshold Mth1 as the first time T1 during which the user is holding the writing implement P. In addition, the measurement processor 112 counts the time during which the acceleration of the writing implement P exceeds a second threshold Mth2 (it should be noted that Mth1<Mth2) as the second time T2 during which the user is holding the writing implement P and writing.

In general, since the acceleration is detected simply when the user is holding the writing implement P, if the acceleration is detected, it can be detected that the user is holding the writing implement P. Accordingly, the first threshold Mth1 shown in FIG. 25 may be set, for example, as a lower limit at which the acceleration can be detected. In this case, if the acceleration is below the first threshold Mth1, the measurement processor 112 may determine that the user is not holding the writing implement P. For example, the measurement processor 112 may count a time during which the acceleration of the writing implement P does not exceed the first threshold Mth1 as a sixth time T6 during which the user is not holding the writing implement P. As another embodiment, the measurement processor 112 may count a time during which the acceleration of the writing implement P does not exceeds the first threshold Mth1 as a sixth time T6 during which the user is holding the writing implement P without moving the writing implement P at all.

In addition, the measurement processor 112 counts a time during which the acceleration of the writing implement P exceeds the first threshold Mth1 and does not exceeds the second threshold Mth2 as the third time T3 during which the user is holding the writing implement P but not writing, that is, the user is holding the writing implement P and thinking.

In general, when the user is holding writing implement P and writing (performing the act of writing), an acceleration of a predetermined value or more is detected, and when the user is thinking while holding the writing implement P without performing the act of writing, an acceleration smaller than the acceleration during the act of writing is detected. Accordingly, when the acceleration of a predetermined value or more is detected, it can be determined that the user is performing the act of writing, and when the acceleration less than the predetermined value is detected, it can be determined that the user is thinking without performing the act of writing.

In addition, the measurement processor 112 does not count, as the second time T2, a time during which the acceleration of the writing implement P exceeds the third threshold Mth3 when the acceleration of the writing implement P exceeds the second threshold Mth2 (it should be noted that Mth2<Mth3). In this case, the measurement processor 112 counts the time during which the acceleration of the writing implement P exceeds the third threshold Mth3 as the fourth time T4 during which the user is holding the writing implement P but not writing, that is, the user is playing with it.

In general, when the user is performing the act of writing, the acceleration of a predetermined value or more is detected as described above, but if the detected acceleration is too large, there is a high possibility that a different act from the act of writing is being performed. For example, if the user is shaking, turning, or rolling the writing implement P, an acceleration larger than the acceleration during the act of writing is detected. Accordingly, if the acceleration is too large, it can be detected that the user is playing with the writing implement P. In other words, the third threshold Mth3 can be set as the upper limit of the act of writing. Accordingly, the measurement processor 112 counts the second time T2 by excluding the time during which the acceleration of the writing implement P exceeds the third threshold Mth3 from the time during which the acceleration of the writing implement P exceeds the second threshold Mth2, and counts the time during which the acceleration of the writing implement P exceeds the third threshold Mth3 as the fourth time T4 during which the user is playing with the writing implement P.

In such a manner, the measurement processor 112 counts the remaining time (time of not writing), which is obtained by excluding the time of writing (second time T2) from the time during which the user is holding the writing implement P (first time T1), as a time of thinking (third time T3) when the acceleration is small or as a time of not thinking (time of playing) (fourth time T4) when the acceleration is large.

As described above, the measurement processor 112 separately counts, in accordance with the acceleration of the writing implement P, the time during which the user is holding the writing implement P (first time T1), the time during which the user is writing with the writing implement P (second time T2), the time during which the user is holding the writing implement P and thinking (third time T3), and the time during which the user is holding the writing implement P and playing with it (fourth time T4).

Here, the time of writing (second time T2), the time of thinking (third time T3), and the time of playing (fourth time T4) can be regarded as the time during which the user is using (holding) the writing implement P, and thus the measurement processor 112 may calculate the total time of the second time T2, the third time T3, and the fourth time T4 as the time of holding (first time T1). In addition, the time of writing (second time T2) and the time of thinking (third time T3) can be regarded as the time during which the user is learning, and thus the measurement processor 112 may calculate the total time of the second time T2 and the third time T3 as a study time (seventh time T7). Note that, in the present invention, only the time of writing (second time T2) may be defined as the study time, or the total time of the time of writing (second time T2) and the time of thinking (third time T3) may be defined as the study time (seventh time T7).

In addition to the acceleration of the writing implement P, the measurement processor 112 may measure the time corresponding to the usage state on the basis of the angle of the writing implement P with respect to the writing surface. In general, when the user is holding the writing implement P, an angle of a predetermined angle or more with respect to the writing surface of the writing implement P is detected. Accordingly, when the angle of a predetermined angle or more is detected, it can be determined that the user is holding the writing implement P, and when an angle less than the predetermined angle is detected, it can be determined that the user is not holding the writing implement P (the writing implement P is put on the desk). In addition, it is also conceivable that an acceleration is detected when the angle of the writing implement P is less than the predetermined angle. For example, the writing implement P placed on the desk may move when it hits the user's hand, or it may fall from the desk to the floor. Accordingly, when the angle of the writing implement P with respect to the writing surface is less than a predetermined angle even if an acceleration is detected, it can be determined that the user is not holding the writing implement P.

In this case, the measurement processor 112 counts the time during which the angle of the writing implement P does not exceed a predetermined angle Dth (angle threshold) as the fifth time T5 during which the user is not holding the writing implement P (see FIG. 25). In addition, when the angle of the writing implement P is considered, the measurement processor 112 counts the first time T1, the second time T2, the third time T3, and the fourth time T4 when the angle exceeds the predetermined angle Dth. In other words, the measurement processor 112 executes the measurement processing for the first time T1, the second time T2, the third time T3, and the fourth time T4 under the condition that the angle of the writing implement P exceeds the predetermined angle Dth. In addition, the measurement processor 112 may count the total time of the fifth time T5 and the sixth time T6 as the time during which the user is not holding (not using) the writing implement P.

Note that the total time from the second time T2 to the sixth time T6 corresponds to the time during which the power supply of the writing apparatus 1 is turned on. The measurement processor 112 may count the total time from the second time T2 to the sixth time T6 as the usage time of the writing apparatus 1. According to the above measurement method, it is possible to accurately grasp the usage state of the writing implement P by the user.

### Setting Method for Threshold

The threshold for determining the usage state of the writing implement P by the user as described above (the first threshold Mth1 and the second threshold Mth2 of the acceleration, the predetermined angle Dth of the angle) may be set depending on the user. In addition, the threshold may be set depending on the writing object (mechanical pencil, ballpoint pen, pencil, electronic pen (touch pen, stylus pen, etc.)). Specifically, the writing system 10 may set the threshold by using at least one of the [Calibration Function 1] or [Calibration Function 2] described above.

This makes it possible to appropriately determine each usage state for each user and to calculate the time corresponding to each usage state (first time T1 to seventh time T7). In addition, this makes it possible to appropriately determine each usage state for each writing object and to calculate the time corresponding to each usage state (first time T1 to seventh time T7).

In addition, the first threshold Mth1 and the second threshold Mth2 of the acceleration of the writing implement P may be set in accordance with the predetermined angle Dth of the angle of the writing implement P. For example, when the angle of the writing implement P with respect to the writing surface falls within a predetermined range (e.g., substantially 40 to substantially 60 degrees), it is conceivable that the user is performing the act of writing (in the state of writing), not in the state of thinking, even if the detected acceleration is small. When the angle falls within a predetermined range (e.g., substantially 40 to substantially 60 degrees), it is also conceivable that the user is performing the act of writing, not playing, even if the detected acceleration is large. In other words, it is also conceivable that even if the acceleration of the writing implement P is the same, the usage state of the writing implement P changes depending on the angle of the writing implement P.

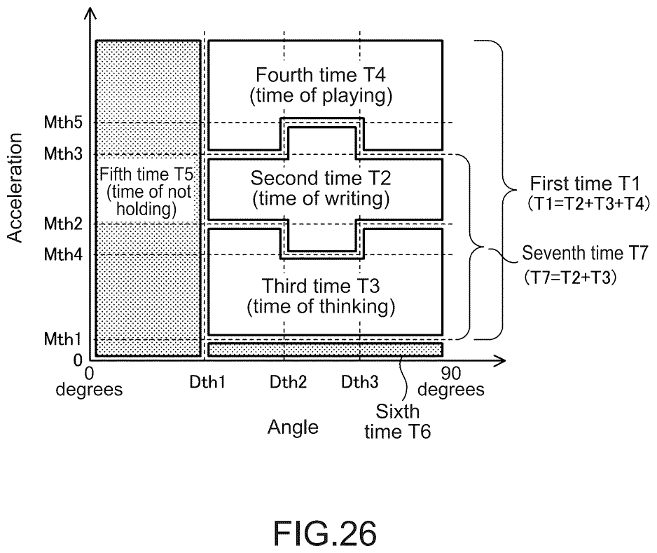

In this regard, in addition to the first threshold Mth1 and the second threshold Mth2 of the acceleration of the writing implement P and the predetermined angle Dth of the angle of the writing implement P, the writing system 10 may further set a fourth threshold Mth4 (it should be noted that Mth1<Mth4<Mth2) and a fifth threshold Mth5 (it should be noted that Mth3<Mth5), which are thresholds of the acceleration, and predetermined angles Dth2 and Dth3 (it should be noted that Dth1<Dth2<Dth3), which are thresholds of the angle (see FIG. 26).

The measurement processor 112 then measures the time corresponding to each usage state on the basis of each of the thresholds described above. For example, as shown in FIG. 26, the measurement processor 112 counts the time during which the angle of the writing implement P exceeds the predetermined angle Dth1 and the acceleration of the writing implement P falls within the range of the second threshold Mth2 and the third threshold Mth3, the time during which the angle of the writing implement P falls within the range of the second threshold Mth2 to the third threshold Mth3 and the acceleration of the writing implement P falls within the range of the fourth threshold Mth4 to the second threshold Mth2, and the time during which the angle of the writing implement P falls within the range of the second threshold Mth2 to the third threshold Mth3 and the acceleration of the writing implement P falls within the range of the third threshold Mth3 to the fifth threshold Mth5, as the time during which the user is holding the writing implement P in hand (second time T2).

In such a manner, the writing system 10 may determine the usage state by giving importance (priority) to the factor of the angle of the writing implement P. For example, when the angle of the writing implement P falls within a predetermined range (range of the predetermined angles Dth2 to Dth3), the writing system 10 may set the range of the acceleration (range of the fourth threshold Mth4 to the fifth threshold Mth5) counted as the time of writing (second time T2) to be wider than the range of acceleration (range of the second threshold Mth2 to the third threshold Mth3) in the case of the angle outside the predetermined range (range of the predetermined angles Dth1 to Dth2, and Dth3 to 90 degrees). Note that the range of the predetermined angles Dth2 to Dth3 may vary depending on the user and the writing object, and thus the writing system 10 may set the predetermined angles Dth2 and Dth3 by the calibration function described above.

Note that the configuration described in the section [Other Embodiments of Measurement Processing] described above can also be applied to a well-known writing system. Specifically, the aforementioned method of measuring the time shown in FIGS. 24 to 26 can be applied to well-known technologies. For example, the aforementioned measurement method can be applied to a well-known electronic pen. In this case, the electronic pen may incorporate the controller 11 that executes the measurement processing described above. In other words, the writing apparatus 1 that executes the measurement method need not have a configuration in which the main body lower part 1B is removably attached to the main body upper part 1A and is replaceable depending on the writing object (see FIG. 7 etc.).

In addition, the storage 12 may store a measurement program for causing the controller 11 to perform the measurement processing described above. For example, the measurement program is non-transiently recorded on a computer-readable recording medium such as a CD or a DVD, read by a reader (not shown) of the writing apparatus 1, and stored in the storage 12. In addition, the measurement program may also be a program for causing one or more processors to function as the processor(s).

### Another Display Method for Measured Time

The writing system 10 may display each of the times measured by the measurement processor 112 on the operation terminal 2. Specifically, the controller 11 of the writing apparatus 1 displays at least one of the times described above on the display (operation terminal 2) that displays the usage state of the writing implement P. The controller 11 transmits the measurement results to the operation terminal 2 and causes the operation terminal 2 to execute the processing of displaying the measurement results.

For example, as shown in (a) of FIG. 19, the display processor 212 of the operation terminal 2 displays the total time (seventh time T7) of the time of writing until now (second time T2) and the time of thinking (third time T3) as a study time (“motivating time”) on the home screen D1. In addition, the display processor 212 may display the second time T2 in a distinguishable manner so as to grasp the time during which the user is actually writing. For example, the display processor 212 may display only the second time T2 among the times described above or may display the second time T2 in a different form (in different color or the like) from the other times.

In addition, the display processor 212 may display the time corresponding to the contents of the user's settings. For example, the user may be able to set and switch between “display” and “non-display” for each of the first time T1 to the seventh time T7. In addition, the display processor 212 may allow a specific user (e.g., a user of a paid plan, a user who has studied for more than a predetermined time, etc.) to view the first time T1 to the seventh time T7.

### Other Configurations of Writing System 10

The writing system 10 may include a management server. Specifically, the management server is capable of data communication with a plurality of operation terminals 2 that use the writing application, and acquires and manages the data related to the act of writing from each of the plurality of operation terminals 2. In addition, the management server also determines items and other users (friends) to be displayed on the sugoroku screen D6 of the operation terminal 2, and transmits learning information of other users to the operation terminal 2. Additionally, the management server may also transmit the analysis results of learning information of a plurality of users, statistical data, etc. to each operation terminal 2.

The measurement system of the present invention is not limited to the learning by the act of writing, but can be applied to various acts. For example, the measurement system can be applied to electronic apparatuses such as PCs, musical instruments, and acts such as sports. Specifically, in an electronic apparatus, when a measurement apparatus having the function of the writing apparatus 1 is attached to a user's finger, the measurement system acquires information on the act (e.g., the act of typing) corresponding to the operation of the fingers. In addition, when the measurement apparatus is attached to an input apparatus (touch panel, keyboard, mouse, smartphone, etc.), the measurement system acquires information on the act (e.g., the act of inputting) corresponding to the operation (vibration etc.) of the input apparatus. In addition, in a musical instrument, when the measurement apparatus having the function of the writing apparatus 1 is attached to a user's finger or the musical instrument, the measurement system acquires information on the act (playing the musical instrument) corresponding to the operation of the finger or musical instrument. Additionally, in sports, when the measurement apparatus having the function of the writing apparatus 1 is attached to the user's body or sports equipment, the measurement system acquires information on the act (exercise) corresponding to the operation of the body or sports equipment. Each of those objects to which the measurement apparatus is attached corresponds to an object to be measured in the present invention. In other words, the present invention is applicable to a system that measures a user's act in various fields.

In addition, the measurement system acquires the acceleration of movement corresponding to the use of an object to be measured (writing implement, finger, touch panel, keyboard, mouse, smartphone, etc.) by the user, counts a time during which the acceleration of the object to be measured exceeds a first threshold as a first time during which the user is using the object to be measured, and counts a time during which the acceleration of the object to be measured exceeds a second threshold larger than the first threshold as a second time during which the user is using the object to be measured and performing input. In addition, the measurement system counts a time during which the acceleration of the object to be measured exceeds the first threshold and does not exceed the second threshold as a third time during which the user is using the object to be measured but not performing input. Additionally, the measurement system counts a time during which the acceleration of the object to be measured exceeds a third threshold larger than the second threshold as a fourth time during which the user is using the object to be measured but not performing input.

In the embodiment described above (see FIG. 25), the time during which the acceleration of the writing implement P exceeds the first threshold Mth1 (the time during which the user is holding the writing implement P (first time T1)) corresponds to “the time during which the user is using the object to be measured (first time)”, and the time during which the acceleration of the writing implement P exceeds the second threshold Mth2 and does not exceed the third threshold Mth3 (the time during which the user is holding the writing implement P and writing (second time T2)) corresponds to “the time during which the user is using the object to be measured and performing input (second time)”. In addition, the time during in the acceleration of the writing implement P exceeds the first threshold Mth1 and does not exceed the second threshold Mth2 (the time during which the user is holding the writing implement P and thinking (third time T3)) corresponds to “the time during which the user is using the object to be measured but not performing input (third time)”. Additionally, the time during which the acceleration of the writing implement P exceeds the third threshold Mth3 (the time during which the user is playing with the writing implement P by shaking, turning, or rolling the writing implement P (fourth time T4)) corresponds to “the time during which the user is using the object to be measured but not performing input (fourth time)”.

In addition, the measurement system may also set the thresholds of acceleration (first threshold, second threshold, and third threshold) depending on the object to be measured or the type of object to be measured. For example, when a user performs an input operation (act of writing) on a touch panel using a touch pen, the value of detected data (e.g., acceleration) may be different between when the writing apparatus 1 (measurement apparatus) is attached to the touch pen and when the writing apparatus 1 is attached to the touch panel, even if the user performs the same act of writing. Specifically, the acceleration detected when the writing apparatus 1 is attached to the touch pen is considered to be larger than the acceleration detected when the writing apparatus 1 is attached to the touch panel. Accordingly, the measurement system may set the threshold of the acceleration when the writing apparatus 1 is attached to the touch pen to a higher value and may set the threshold of the acceleration when the writing apparatus 1 is attached to the touch panel to a lower value. In other words, the measurement system may set the threshold when the measurement apparatus is provided on the input side (writing implement, finger, etc.) to a higher value than the threshold value when the measurement apparatus is provided on the input receiving side (touch panel, keyboard, etc.).

### Aspects of Disclosure 1

The outline of the invention extracted from the embodiment described above will be given below. Note that the configurations and processing functions described in the following Aspects of the Disclosure 1 can be discretionally selected and combined. Aspects of the Disclosure 1 mainly show the features of the structure of the writing apparatus 1.

### Clause 1

A measurement apparatus that is attachable to and detachable from an object to be measured and detects data related to an act performed by a user using the object to be measured, the measurement apparatus including:
a first part including a detector that detects the data; and
a second part configured to hold the object to be measured, the second part being removably attached to the first part and replaceable depending on the object to be measured.

### Clause 2

The measurement apparatus according to Clause 1, in which
the second part includes
   a base connected to the first part,
   a first holding portion that extends from one side end of the base in a first direction that is a direction opposite to a connection portion with the first part, and
   a second holding portion that extends from another side end of the base in the first direction, and
a space for accommodating the object to be measured is formed between the first holding portion and the second holding portion.

### Clause 3

The measurement apparatus according to Clause 2, in which
the second part includes
   a first protrusion that protrudes toward the space from a first end of the first holding portion in the first direction, and
   a second protrusion that protrudes toward the space from a second end of the second holding portion in the first direction.

### Clause 4

The measurement apparatus according to Clause 3, in which
the first end including the first protrusion and the second end including the second protrusion are elastically deformable in a direction orthogonal to the first direction.

### Clause 5

The measurement apparatus according to Clause 3 or 4, in which
a plurality of the second parts having different distances between the first protrusion and the second protrusion can be connected to the first part.

### Clause 6

The measurement apparatus according to any one of Clauses 1 to 5, in which
the base accommodates part of the first part inside the base.

### Clause 7

The measurement apparatus according to any one of Clauses 1 to 6, in which
the base accommodates a battery disposed in the first part inside the base,
a charging terminal connected to the battery is exposed to an outside from an opening formed at an end of the base in the first direction.

### Clause 8

The measurement apparatus according to any one of Clauses 1 to 7, in which
the detector detects an acceleration of movement of the object to be measured, and determines presence or absence of the act on the basis of whether or not the detected acceleration exceeds a threshold, and
the threshold is set on the basis of a position, to which the measurement apparatus is attached, of the object to be measured.

### Clause 9

The measurement apparatus according to any one of Clauses 1 to 8, in which
the detector detects an acceleration of movement of the object to be measured, and determines presence or absence of the act on the basis of whether or not the detected acceleration exceeds a threshold, and
the threshold is set in accordance with the object to be measured.

### Clause 10

A measurement system, including:
the measurement apparatus according to any one of Clauses 1 to 9; and
an operation terminal capable of communicating with the measurement apparatus, the operation terminal displaying information related to the act on the basis of the data acquired from the measurement apparatus.

### Aspects of Disclosure 2

The outline of the invention extracted from the embodiment described above will be given below. Note that the configurations and processing functions described in the following Aspects of the Disclosure 2 can be discretionally selected and combined. Aspects of the Disclosure 2 mainly show the features of the processing (measurement processing etc.) of the writing apparatus 1.

### Clause 1

A measurement system, including:
an acquisition processor that acquires an acceleration of movement corresponding to a usage of an object to be measured by a user; and
a measurement processor that counts a time during which the acceleration of the object to be measured exceeds a first threshold as a first time during which the user is using the object to be measured, and counts a time during which the acceleration of the object to be measured exceeds a second threshold larger than the first threshold as a second time during which the user is using the object to be measured and performing input.

### Clause 2

The measurement system according to Clause 1, in which
the measurement processor counts a time during which the acceleration of the object to be measured exceeds the first threshold and does not exceed the second threshold as a third time during which the user is using the object to be measured but not performing input.

### Clause 3

The measurement system according to Clause 1 or 2, in which
the measurement processor does not count a time during which the acceleration of the object to be measured exceeds a third threshold larger than the second threshold as the second time.

### Clause 4

The measurement system according to Clause 3, in which
the measurement processor counts a time during which the acceleration of the object to be measured exceeds the third threshold as a fourth time during which the user is using the object to be measured but not performing input.

### Clause 5

The measurement system according to any one of Clauses 1 to 4, in which
the acquisition processor acquires an angle of the object to be measured that is being used by the user, and
the measurement processor counts a time during which the angle of the object to be measured does not exceed a predetermined angle as a fifth time during which the user is not using the object to be measured.

### Clause 6

The measurement system according to Clause 5, in which
the measurement processor counts the first time or the second time when the angle of the object to be measured exceeds the predetermined angle.

### Clause 7

The measurement system according to Clause 5 or 6, in which
the predetermined angle is set in accordance with the object to be measured or the user.

### Clause 8

The measurement system according to any one of Clauses 5 to 7, in which
the first threshold and the second threshold are set in accordance with the angle of the object to be measured.

### Clause 9

The measurement system according to any one of Clauses 1 to 8, in which
the first threshold and the second threshold are set in accordance with the object to be measured or the user.

### Clause 10

The measurement system according to any one of Clauses 1 to 9, in which
the measurement processor counts a time during which the acceleration of the object to be measured does not exceed the first threshold as a sixth time during which the user is not using the object to be measured.

### Clause 11

The measurement system according to any one of Clauses 1 to 10, in which
the acquisition processor acquires the acceleration from a measurement apparatus attached to the object to be measured.

### Clause 12

The measurement system according to any one of Clauses 1 to 11, in which
the second time is displayed in a distinguishable manner on a display that displays a usage state of the object to be measured.

### Clause 13

A measurement apparatus that is attachable to and detachable from an object to be measured and detects data related to a usage of the object to be measured by a user, the measurement apparatus including:
a first part including
   a detector that detects the data, and
   a controller that acquires the data detected by the detector; and
a second part configured to hold the object to be measured, the second part being removably attached to the first part and replaceable depending on the object to be measured,
the controller including
   an acquisition processor that acquires an acceleration of movement corresponding to the usage of the object to be measured by the user, and
   a measurement processor that counts a time during which the acceleration of the object to be measured exceeds a first threshold as a first time during which the user is using the object to be measured, and counts a time during which the acceleration of the object to be measured exceeds a second threshold larger than the first threshold as a second time during which the user is using the object to be measured and performing input.

### Clause 14

A measurement method that is executed by one or more processors, the measurement method including:
acquiring an acceleration of movement corresponding to a usage of an object to be measured by a user; and
counting a time during which the acceleration of the object to be measured exceeds a first threshold as a first time during which the user is using the object to be measured, and counting a time during which the acceleration of the object to be measured exceeds a second threshold larger than the first threshold as a second time during which the user is using the object to be measured and performing input.

### Clause 15

A non-transitory computer-readable recording medium that records a measurement program for causing one or more processors to execute:
acquiring an acceleration of movement corresponding to a usage of an object to be measured by a user; and
counting a time during which the acceleration of the object to be measured exceeds a first threshold as a first time during which the user is using the object to be measured, and counting a time during which the acceleration of the object to be measured exceeds a second threshold larger than the first threshold as a second time during which the user is using the object to be measured and performing input.

It is to be understood that the embodiments herein are illustrative and not restrictive, since the scope of the disclosure is defined by the appended claims rather than by the description preceding them, and all changes that fall within metes and bounds of the claims, or equivalence of such metes and bounds thereof are therefore intended to be embraced by the claims.

1. A measurement system, comprising:
an acquisition processor that acquires an acceleration of movement corresponding to a usage of an object to be measured by a user; and
a measurement processor that counts a time during which the acceleration of the object to be measured exceeds a first threshold as a first time during which the user is using the object to be measured, and counts a time during which the acceleration of the object to be measured exceeds a second threshold larger than the first threshold as a second time during which the user is using the object to be measured and performing input.

2. The measurement system according to claim 1, wherein
the measurement processor counts a time during which the acceleration of the object to be measured exceeds the first threshold and does not exceed the second threshold as a third time during which the user is using the object to be measured but not performing input.

3. The measurement system according to claim 1, wherein
the measurement processor does not count a time during which the acceleration of the object to be measured exceeds a third threshold larger than the second threshold as the second time.

4. The measurement system according to claim 3, wherein
the measurement processor counts a time during which the acceleration of the object to be measured exceeds the third threshold as a fourth time during which the user is using the object to be measured but not performing input.

5. The measurement system according to claim 1, wherein
the acquisition processor acquires an angle of the object to be measured that is being used by the user, and
the measurement processor counts a time during which the angle of the object to be measured does not exceed a predetermined angle as a fifth time during which the user is not using the object to be measured.

6. The measurement system according to claim 5, wherein
the measurement processor counts the first time or the second time when the angle of the object to be measured exceeds the predetermined angle.

7. The measurement system according to claim 5, wherein
the predetermined angle is set in accordance with the object to be measured or the user.

8. The measurement system according to claim 5, wherein
the first threshold and the second threshold are set in accordance with the angle of the object to be measured.

9. The measurement system according to claim 1, wherein
the first threshold and the second threshold are set in accordance with the object to be measured or the user.

10. The measurement system according to claim 1, wherein
the measurement processor counts a time during which the acceleration of the object to be measured does not exceed the first threshold as a sixth time during which the user is not using the object to be measured.

11. The measurement system according to claim 1, wherein
the acquisition processor acquires the acceleration from a measurement apparatus attached to the object to be measured.

12. The measurement system according to claim 1, wherein
the second time is displayed in a distinguishable manner on a display that displays a usage state of the object to be measured.

13. A measurement apparatus that is attachable to and detachable from an object to be measured and detects data related to a usage of the object to be measured by a user, the measurement apparatus comprising:
a first part comprising
a detector that detects the data, and
a controller that acquires the data detected by the detector; and
a second part configured to hold the object to be measured, the second part being removably attached to the first part and replaceable depending on the object to be measured,
the controller comprising
an acquisition processor that acquires an acceleration of movement corresponding to the usage of the object to be measured by the user, and
a measurement processor that counts a time during which the acceleration of the object to be measured exceeds a first threshold as a first time during which the user is using the object to be measured, and counts a time during which the acceleration of the object to be measured exceeds a second threshold larger than the first threshold as a second time during which the user is using the object to be measured and performing input.

14. A measurement method that is executed by one or more processors, the measurement method comprising:
acquiring an acceleration of movement corresponding to a usage of an object to be measured by a user; and
counting a time during which the acceleration of the object to be measured exceeds a first threshold as a first time during which the user is using the object to be measured, and counting a time during which the acceleration of the object to be measured exceeds a second threshold larger than the first threshold as a second time during which the user is using the object to be measured and performing input.
